(19) United States
(12) Patent Application Publication
(10) Pub. No.: US 2008/0077412 A1
(43) Pub. Date: Mar. 27, 2008

(54) Method, medium, and system encoding and/or decoding audio signals by using bandwidth extension and stereo coding

(75) Inventors: Eun-mi Oh, Seongnam-si (KR); Ki-hyun Choo, Seoul (KR); Jung-hoe Kim, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/902,650

(22) Filed: Sep. 24, 2007

(30) Foreign Application Priority Data
Sep. 22, 2006 (KR) 10-2006-0092459
Aug. 28, 2007 (KR) 10-2007-0086337

(51) Int. Cl. G10L 19/00

(52) U.S. Cl. 704/500

(57) ABSTRACT

A method, medium, and system encoding and/or decoding an audio signal by extracting stereo parameters from an input signal, encoding the stereo parameters, and performing down-mixing on the input signal to a down-mixed signal, splitting the down-mixed signal into a low band signal and a high band signal, determining whether to encode the low band signal in a time domain or a frequency domain, if the low band signal is determined to be encoded in the time domain, encoding the low band signal in the time domain, if the low band signal is determined to be encoded in the frequency domain, generating an encoded bitplane by converting the low band signal from the time domain to the frequency domain by using a first conversion method and performing quantization and context-dependent encoding on the low band signal converted to the frequency domain by using the first conversion method, converting each of the low band signal and the high band signal from the time domain to the frequency domain or a time/frequency domain by using a second conversion method, generating and encoding bandwidth extension information that represents a characteristic of the high band signal converted by the second conversion method by using the low band signal converted by the second conversion method, and outputting the encoded stereo parameters, the encoded bitplane, and the encoded bandwidth extension information a result of encoding the input signal. Accordingly, high frequency components and stereo components may be efficiently encoded and decoded at a potential restricted bit rate, thereby improving the quality of an audio signal.

### CROSS-REFERENCE TO RELATED APPLICATIONS

This application claims the benefit of Korean Patent Application No. 10-2006-0092459, filed on Sep. 22, 2006, and Korean Patent Application No. 10-2007-0086337, filed on Aug. 28, 2007, in the Korean Intellectual Property Office, the disclosures of which are incorporated herein in their entirety by reference.

### BACKGROUND

1. Field

One or more embodiments of the present invention relate to a method, medium, and system encoding and/or decoding an audio signal, and more particularly, to a method, medium, and system encoding and/or decoding an audio signal by using bandwidth extension and stereo coding.

2. Description of the Related Art

When audio signals are encoded or decoded, the quality of the audio signals should typically be maximized by using restricted bit rates. The amount of bits available at a low bit rate is small and thus an audio signal has to be encoded or decoded by reducing the frequency bandwidth of the audio signal. Accordingly, the quality of the audio signal may deteriorate.

In general, low frequency components are more important for humans to recognize audio signals in comparison with high frequency components. Accordingly, the inventors of the present invention have determined, as explained herein, that a method of improving the quality of audio signals by increasing the amount of bits allocated to encode the low frequency components and by reducing the amount of bits allocated to encode the high frequency components may be desired and helpful.

Furthermore, compared to mono signals having a single channel, a larger amount of bits are allocated for encoding or decoding a stereo signal having two or more channels. Accordingly, similarly, the inventors of the present invention have determined, as explained herein, that a method of reducing the amount of bits to be allocated for coding a stereo signal and improving the quality of the stereo signal may be desired and helpful.

### SUMMARY

One or more embodiments of the present invention provides a method, medium, and system encoding an audio signal in which stereo components and high frequency components are efficiently encoded at a restricted bit rate, resulting in improved audio signal quality.

One or more embodiments of the present invention also provides a method, medium, and system that may efficiently decode high frequency components and stereo components from a bitstream encoded at a restricted bit rate.

Additional aspects and/or advantages will be set forth in part in the description which follows and, in part, will be apparent from the description, or may be learned by practice of the invention.

According to another aspect of the present invention, there is provided a method of encoding an audio signal, the method including: (a) extracting stereo parameters from an input signal, encoding the stereo parameters, and performing down-mixing on the input signal to a down-mixed signal; (b) splitting the down-mixed signal into a low band signal and a high band signal; (c) determining whether to encode the low band signal in a time domain or a frequency domain; (d) if the low band signal is determined to be encoded in the time domain, encoding the low band signal in the time domain; (e) if the low band signal is determined to be encoded in the frequency domain, generating an encoded bitplane by converting the low band signal from the time domain to the frequency domain by using a first conversion method and performing quantization and context-dependent encoding on the low band signal converted to the frequency domain by using the first conversion method; (f) converting each of the low band signal and the high band signal from the time domain to the frequency domain or a time/frequency domain by using a second conversion method; (g) generating and encoding bandwidth extension information that represents a characteristic of the high band signal converted by the second conversion method by using the low band signal converted by the second conversion method; and (h) outputting the encoded stereo parameters, the encoded bitplane, and the encoded bandwidth extension information a result of encoding the input signal.

According to another aspect of the present invention, there is provided a method of decoding an audio signal, the method including: (a) receiving an encoded audio signal; (b) generating a low band signal by performing context-dependent decoding and inverse quantization on an encoded bitplane included in the encoded audio signal; (c) decoding encoded bandwidth extension information included in the encoded audio signal and generating a high band signal from the low band signal by using the decoded bandwidth extension information; (d) inversely converting each of the low band signal and the high band signal from a frequency domain to a time domain by using a first conversion method; (e) combining the inversely converted low band signal and the inversely converted high band signal; and (f) decoding encoded stereo parameters included in the encoded audio signal and performing up-mixing on the combined signal by using the decoded stereo parameters.

According to another aspect of the present invention, there is provided a method of decoding an audio signal, the method including: (a) receiving an encoded audio signal of a time domain or a frequency domain; (b) generating a low band signal by performing context-dependent decoding and inverse quantization on an encoded bitplane included in the encoded audio signal of the frequency domain; (c) inversely converting the low band signal to the time domain by using a first inverse conversion method; (d) converting the low band signal inversely converted to the time domain by using the first inverse conversion method to the frequency domain or the time/frequency domain; (e) decoding encoded bandwidth extension information included in the encoded audio signal of the frequency domain and generating a high band signal from the low band signal converted to the frequency domain or the time/frequency domain by the first conversion method by using the decoded bandwidth extension information; (f) inversely converting the high band signal to the time domain by using a second inverse conversion method; (g) generating the low band signal by decoding the encoded audio signal of the time domain in the time domain; (h) combining the signal inversely converted to the time domain by the first inverse conversion method, the high band signal inversely converted to the time domain by the second inverse conversion method, and the low band signal decoded in the time domain; and (i) decoding encoded stereo parameters included in the encoded audio signal and performing up-mixing on the combined signal by using the decoded stereo parameters.

According to another aspect of the present invention, there is provided a computer readable medium having computer readable code to implement a method of decoding an audio signal, the method including: (a) receiving an encoded audio signal of a time domain or a frequency domain; (b) generating a low band signal by performing context-dependent decoding and inverse quantization on an encoded bitplane included in the encoded audio signal of the frequency domain; (c) inversely converting the low band signal to the time domain by using a first inverse conversion method; (d) converting the low band signal inversely converted to the time domain by using the first inverse conversion method to the frequency domain or the time/frequency domain; (e) decoding encoded bandwidth extension information included in the encoded audio signal of the frequency domain and generating a high band signal from the low band signal converted to the frequency domain or the time/frequency domain by the first conversion method by using the decoded bandwidth extension information; (f) inversely converting the high band signal to the time domain by using a second inverse conversion method; (g) generating the low band signal by decoding the encoded audio signal of the time domain in the time domain; (h) combining the signal inversely converted to the time domain by the first inverse conversion method, the high band signal inversely converted to the time domain by the second inverse conversion method, and the low band signal decoded in the time domain; and (i) decoding encoded stereo parameters included in the encoded audio signal and performing up-mixing on the combined signal by using the decoded stereo parameters.

According to another aspect of the present invention, there is provided a method of decoding an audio signal, the method including: (a) receiving an encoded audio signal of a time domain or a frequency domain; (b) performing context-dependent decoding and inverse quantization on an encoded bitplane included in the encoded audio signal of the frequency domain; (c) decoding the encoded audio signal of the time domain in the time domain; (d) inversely converting the signal inversely quantized in (b) or the signal decoded in (c) to the time domain by performing inverse frequency varying modulated lapped transformation (FV-MLT) on the signal inversely quantized in (b) or the signal decoded in (c); (e) converting the inversely converted signal to the frequency domain or the time/frequency domain; (f) decoding encoded bandwidth extension information included in the encoded audio signal and generating a full band signal from the signal converted to the frequency domain or the time/frequency domain by using the decoded bandwidth extension information; (g) decoding encoded stereo parameters included in the encoded audio signal and performing up-mixing on the full band signal by using the decoded stereo parameters; and (h) inversely converting the signal on which the up-mixing is performed to the time domain.

### BRIEF DESCRIPTION OF THE DRAWINGS

These and/or other aspects and advantages will become apparent and more readily appreciated from the following description of the embodiments, taken in conjunction with the accompanying drawings of which:

FIGS. 1-6 illustrate systems encoding an audio signal, according to example embodiments of the present invention;

FIGS. 7-12 illustrate systems decoding an audio signal, according to example embodiments of the present invention;

FIGS. 13-17 illustrate methods of encoding an audio signal, according to example embodiments of the present invention; and

FIGS. 18-22 illustrate methods of decoding an audio signal, according to example embodiments of the present invention.

### DETAILED DESCRIPTION OF THE EMBODIMENTS

Reference will now be made in detail to embodiments, examples of which are illustrated in the accompanying drawings, wherein like reference numerals refer to the like elements throughout. In this regard, embodiments of the present invention may be embodied in many different forms and should not be construed as being limited to embodiments set forth herein. Accordingly, embodiments are merely described below, by referring to the figures, to explain aspects of the present invention.

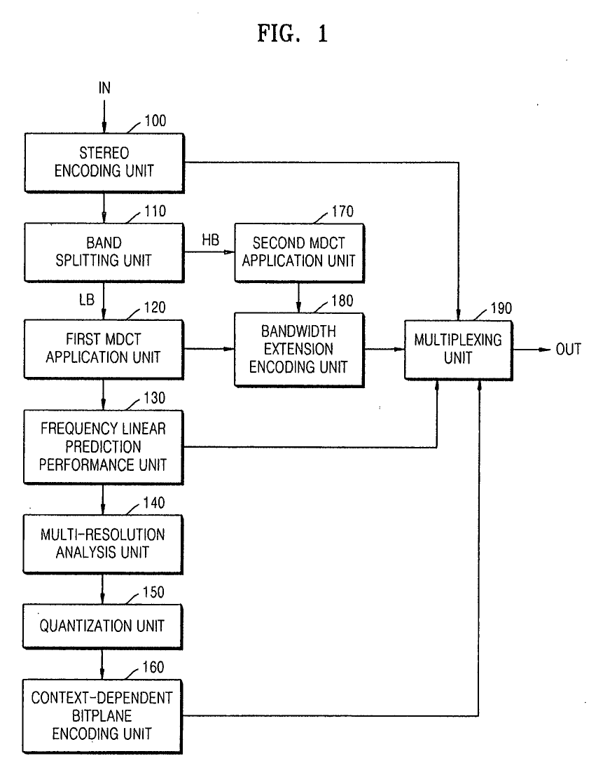

FIG. 1 illustrates a system encoding an audio signal, according to an embodiment of the present invention.

Referring to FIG. 1, the system may include a stereo encoding unit 100, a band splitting unit 110, a first modified discrete cosine transformation (MDCT) application unit 120, a frequency linear prediction performance unit 130, a multi-resolution analysis unit 140, a quantization unit 150, a context-dependent bitplane encoding unit 160, a second MDCT application unit 170, a bandwidth extension encoding unit 180, and a multiplexing unit 190, for example, and may be a single processing element system embodiment through at least a computer system embodiment, including through potentially distributed networks, to achieve the advantages of the present invention not previously available.

The stereo encoding unit 100 may extract stereo, or plural, parameters from an input signal IN, encode the stereo parameters, and perform down-mixing on the input signal IN. Here, the input signal IN may be a pulse code modulation (PCM) signal in which an analog speech or audio signal is modulated into a digital signal, and the down-mixing, for example, is a collapsing process for generating a mono signal having one channel from a stereo signal having two or more channels. By performing such down-mixing, the overall amount of bits to be allocated for encoding the input signal IN may be reduced.

In more detail, the stereo parameters may include side information on a stereo signal. Here, further, it should be understood that this side information may include various pieces of information, such as the phase difference or the intensity difference of channels of left-channel and right-channel signals, for example.

The band splitting unit 110 may split the down-mixed signal into a low band signal LB and a high band signal HB. Herein, the low band signal LB may be a frequency signal lower, for example, than a predetermined threshold value, and the high band signal HB may be a frequency signal higher than the example predetermined threshold value, noting that alternatives are further available.

The first MDCT application unit 120 may further perform MDCT on the low band signal LB split by the band splitting unit 110, so as to convert the low band signal LB from the time domain to the frequency domain. Here, the time domain represents variations in amplitude such as energy or sound pressure of the input signal IN according to time and the frequency domain represents variations in amplitude of the input signal IN according to frequency.

The frequency linear prediction performance unit 130 may perform frequency linear prediction on the frequency domain low band signal. Here, the frequency linear prediction approximates a current frequency signal to a linear combination of a previous frequency signal. In more detail, the frequency linear prediction performance unit 130 may calculate coefficients of a linear prediction filter so as to minimize prediction errors that are differences between a linearly predicted signal and the current frequency signal, and perform linear prediction filtering on the frequency domain low band signal LB in accordance with the calculated coefficients. Here, the frequency linear prediction performance unit 130 may improve the encoding efficiency by performing vector quantization on corresponding values of coefficients of a linear prediction filter so as to represent the corresponding values by using vector indices, noting that alternative embodiments are further available.

In further detail, if the frequency domain low band signal LB is speech or a pitched signal, the frequency linear prediction performance unit 130 may perform the frequency linear prediction on the speech signal or pitched signal. That is, the frequency linear prediction performance unit 130 may further improve the encoding efficiency by selectively performing the frequency linear prediction in accordance with a characteristic of a received signal.

The multi-resolution analysis unit 140 may receive the frequency domain low band signal LB or a result of the frequency linear prediction performance unit 130, and perform multi-resolution analysis on audio spectrum coefficients of the received signal that instantaneously vary. In more detail, the multi-resolution analysis unit 140 may perform the multi-resolution analysis on an audio spectrum filtered by the frequency linear prediction performance unit 130, for example, by dividing the audio spectrum into two types, such as a stable type and a short type, in accordance with the intensity of audio spectrum variations.

In further detail, for example, if the frequency domain low band signal LB or the result of the frequency linear prediction performance unit 130 is a transient signal, the multi-resolution analysis unit 140 may perform the multi-resolution analysis on the transient signal. That is, the multi-resolution analysis unit 140 may also further improve the encoding efficiency by selectively performing the multi-resolution analysis in accordance with a characteristic of the received signal.

The quantization unit 150 may quantize a result of the frequency linear prediction performance unit 130 or the multi-resolution analysis unit 140, for example.

The context-dependent bitplane encoding unit 160 may perform context-dependent encoding on a result of the quantization unit 150 so as to generate an encoded bitplane. Here, the context-dependent bitplane encoding unit 160 may perform the context-dependent encoding by using a Huffman coding method, for example, noting that alternatives are also available.

The frequency linear prediction performance unit 130, the multi-resolution analysis unit 140, the quantization unit 150, and the context-dependent bitplane encoding unit 160 may, thus, encode the frequency domain low band signal LB and thus may be collectively referred to as a low band encoding unit.

The second MDCT application unit 170 may perform the MDCT on the high band signal HB split by the band splitting unit 110 so as to convert the high band signal HB from the time domain to the frequency domain.

In order to transfer components of the frequency domain high band signal HB, the bandwidth extension encoding unit 180 may generate and encode bandwidth extension information that represents a characteristic of the frequency domain high band signal HB by using the frequency domain low band signal LB, e.g., as converted to the frequency domain by the first MDCT application unit 120. Here, it should be understood that the bandwidth extension information may include various pieces of information, such as an energy level and an envelope, of the high band signal HB. In more detail, the bandwidth extension encoding unit 180 may generate the bandwidth extension information by using information on the low band signal LB based on the fact that strong correlations exist between the low band signal LB and the high band signal HB. According to another embodiment of the present invention, the bandwidth extension encoding unit 180 may generate the bandwidth extension information by using a result of encoding the low band signal LB, for example.

The multiplexing unit 190 may further generate a bitstream by multiplexing the encoded results of the stereo encoding unit 100, the frequency linear prediction performance unit 130, the context-dependent bitplane encoding unit 160, and the bandwidth extension encoding unit 180, e.g., so as to output the bitstream as an output signal OUT.

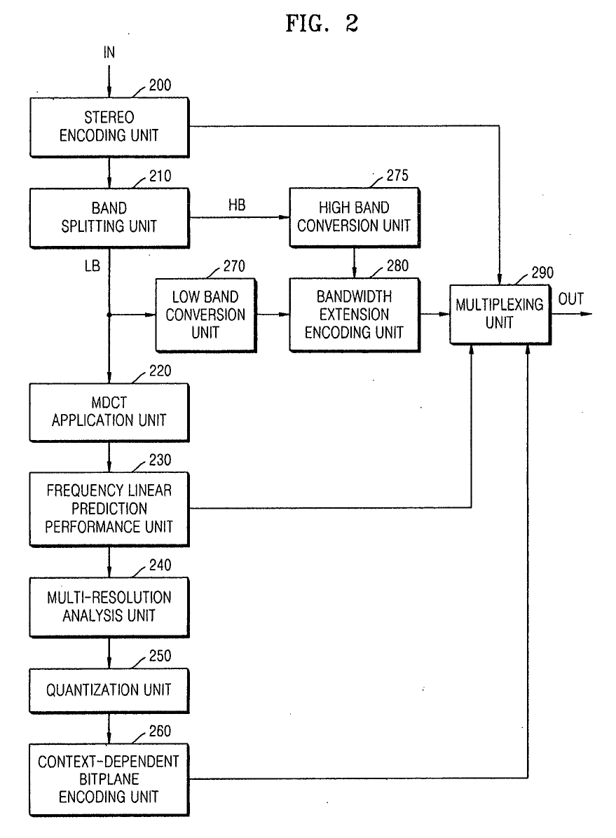

FIG. 2 illustrates a system encoding an audio signal, according to another embodiment of the present invention.

Referring to FIG. 2, the system may include a stereo encoding unit 200, a band splitting unit 210, an MDCT application unit 220, a frequency linear prediction performance unit 230, a multi-resolution analysis unit 240, a quantization unit 250, a context-dependent bitplane encoding unit 260, a low band conversion unit 270, a high band conversion unit 275, a bandwidth extension encoding unit 280, and a multiplexing unit 290, for example, and may be a single processing element system embodiment through at least a computer system embodiment, including through potentially distributed networks, to achieve the advantages of the present invention not previously available.

The stereo encoding unit 200 may extract stereo, or plural, parameters from an input signal IN, encode the stereo parameters, and perform down-mixing on the input signal IN.

The band splitting unit 210 may split the down-mixed signal into an example low band signal LB and a high band signal HB.

The MDCT application unit 220 may perform MDCT on the low band signal LB split by the band splitting unit 210 so as to convert the low band signal LB from the time domain to the frequency domain.

The frequency linear prediction performance unit 230 may further perform frequency linear prediction on the frequency domain low band signal LB. Here, the frequency linear prediction may approximate a current frequency signal to a linear combination of a previous frequency signal. In more detail, in an embodiment, the frequency linear prediction performance unit 230 may calculate coefficients of a linear prediction filter so as to minimize prediction errors that are differences between a linearly predicted signal and the current frequency signal, and perform linear prediction filtering on the low band signal LB converted to the frequency domain in accordance with the calculated coefficients. Here, for example, the frequency linear prediction performance unit 230 may further improve the encoding efficiency by performing vector quantization on corresponding values of coefficients of a linear prediction filter so as to represent the corresponding values by using vector indices.

In further detail, if the frequency domain low band signal LB is speech or a pitched signal, the frequency linear prediction performance unit 230 may selectively perform the frequency linear prediction on the speech signal or pitched signal. That is, the frequency linear prediction performance unit 230 may selectively improve the encoding efficiency by performing the frequency linear prediction in accordance with a characteristic of a received signal.

The multi-resolution analysis unit 240 may receive a result output of the MDCT application unit 220 or the frequency linear prediction performance unit 230, and perform multi-resolution analysis on audio spectrum coefficients of the received signal that instantaneously vary. In more detail, in an embodiment, the multi-resolution analysis unit 240 may perform the multi-resolution analysis on an audio spectrum filtered by the frequency linear prediction performance unit 230 by dividing the audio spectrum into two types, such as a stable type and a short type, in accordance with the intensity of audio spectrum variations, for example.

In further detail, for example, if the frequency domain low band signal LB or a result of the frequency linear prediction performance unit 230 is a transient signal, the multi-resolution analysis unit 240 may perform the multi-resolution analysis on the transient signal. That is, the multi-resolution analysis unit 240 may selectively improve the encoding efficiency by performing the multi-resolution analysis in accordance with a characteristic of the received signal.

The quantization unit 250 may quantize a result of the frequency linear prediction performance unit 230 or the multi-resolution analysis unit 240, for example.

The context-dependent bitplane encoding unit 260 may further perform context-dependent encoding on a result of the quantization unit 250 so as to generate an encoded bitplane. Here, the context-dependent bitplane encoding unit 260 may perform the context-dependent encoding by using a Huffman coding method, for example, noting that alternatives are also available.

The frequency linear prediction performance unit 230, the multi-resolution analysis unit 240, the quantization unit 250, and the context-dependent bitplane encoding unit 260, for example, may thus encode the frequency domain low band signal LB and thus, in an embodiment, may further be collectively referred to as a low band encoding unit.

Depending on embodiment, the low band conversion unit 270 may convert the low band signal LB, e.g., split by the band splitting unit 210, from the time domain to the frequency domain or the time/frequency domain by using a conversion method other than an MDCT method. For example, the low band conversion unit 270 may convert the low band signal LB from the time domain to the frequency domain or the time/frequency domain by using a modified discrete sine transformation (MDST) method, a fast Fourier transformation (FFT) method, or a quadrature mirror filter (QMF) method. Here, the time domain represents variations in amplitude such as energy or sound pressure of the low band signal LB according to time, the frequency domain represents variations in amplitude of the low band signal LB according to frequency, and the time/frequency domain represents variations of amplitude of the low band signal LB according to time and frequency.

Similarly, depending on embodiment, the high band conversion unit 275 may convert the frequency domain high band signal HB, e.g., split by the band splitting unit 210, from the time domain to the frequency domain or the time/frequency domain by using a conversion method other than an MDCT method. Here, the high band conversion unit 275 and the low band conversion unit 270 may use the same conversion method. For example, the high band conversion unit 275 may use the MDST method, the FFT method, or the QMF method, noting that alternatives are equally available.

The bandwidth extension encoding unit 280 may generate and encode bandwidth extension information that represents a characteristic of the converted high band signal HB, e.g., converted to the frequency domain or the time/frequency domain by the high band conversion unit 275, by using the converted low band signal LB, e.g., converted to the frequency domain or the time/frequency domain by the low band conversion unit 270. Here, it should be understood that the bandwidth extension information may include various pieces of information, such as an energy level and an envelope, of the high band signal HB, for example. In more detail, the bandwidth extension encoding unit 280 may generate the bandwidth extension information by using information on the low band signal LB based on the fact that strong correlations exist between the low band signal LB and the high band signal HB. According to another embodiment of the present invention, for example, the bandwidth extension encoding unit 280 may generate the bandwidth extension information by using a result of the encoding of the low band signal LB.

The multiplexing unit 290 may further generate a bitstream, for example, by multiplexing the results encoded by the stereo encoding unit 200, the frequency linear prediction performance unit 230, the context-dependent bitplane encoding unit 260, and the bandwidth extension encoding unit 280 so as to output the bitstream, e.g., as an output signal OUT.

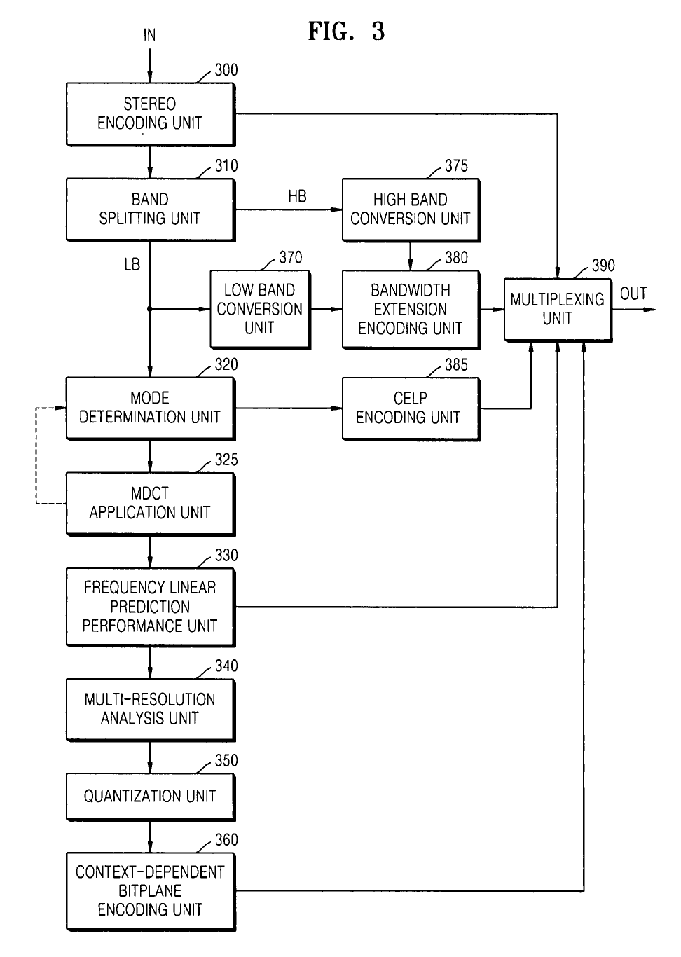

FIG. 3 illustrates a system encoding an audio signal, according to another embodiment of the present invention.

Referring to FIG. 3, the system may include a stereo encoding unit 300, a band splitting unit 310, a mode determination unit 320, an MDCT application unit 325, a frequency linear prediction performance unit 330, a multi-resolution analysis unit 340, a quantization unit 350, a context-dependent bitplane encoding unit 360, a low band conversion unit 370, a high band conversion unit 375, a bandwidth extension encoding unit 380, a code excited linear prediction (CELP) encoding unit 385, and a multiplexing unit 390, for example, and may be a single processing element system embodiment through at least a computer system embodiment, including through potentially distributed networks, to achieve the advantages of the present invention not previously available.

The stereo encoding unit 300 may extract stereo, or plural, parameters from an input signal IN, encode the stereo parameters, and perform down-mixing on the input signal IN.

The band splitting unit 310 may split the down-mixed signal into an example low band signal LB and a high band signal HB.

The mode determination unit 320 may determine whether to encode the low band signal LB, e.g., split by the band splitting unit 310, in the time domain or the frequency domain in accordance with a predetermined standard. For example, the mode determination unit 320 may determine whether to encode the low band signal LB in the time domain or the frequency domain in accordance with a result output from the MDCT application unit 325, for example.

For example, if the mode determination unit 320 determines to encode the low band signal LB in the frequency domain, the MDCT application unit 325 may perform MDCT on the low band signal LB so as to convert the low band signal LB from the time domain to the frequency domain, and a result of the MDCT may be used by the mode determination unit 320 in order to determine an encoding domain.

The frequency linear prediction performance unit 330 may perform frequency linear prediction on the frequency domain low band signal LB. Here, the frequency linear prediction may approximate a current frequency signal to a linear combination of a previous frequency signal. In more detail, for example, the frequency linear prediction performance unit 330 may calculate coefficients of a linear prediction filter so as to minimize prediction errors that are differences between a linearly predicted signal and the current frequency signal, and perform linear prediction filtering on the frequency domain low band signal LB in accordance with the calculated coefficients. Here, in an embodiment, the frequency linear prediction performance unit 330 may, thus, improve the encoding efficiency by performing vector quantization on corresponding values of coefficients of a linear prediction filter so as to represent the corresponding values by using vector indices.

In further detail, if the frequency domain low band signal LB is speech or a pitched signal, the frequency linear prediction performance unit 330 may perform the frequency linear prediction on the speech signal or pitched signal. That is, the frequency linear prediction performance unit 330 may further selectively improve the encoding efficiency by performing the frequency linear prediction in accordance with a characteristic of a received signal.

The multi-resolution analysis unit 340 may receive a result of the MDCT application unit 325 or the frequency linear prediction performance unit 330, for example, and perform multi-resolution analysis on audio spectrum coefficients of the received signal that instantaneously vary. In more detail, in an embodiment, the multi-resolution analysis unit 340 may perform the multi-resolution analysis on an audio spectrum filtered by the frequency linear prediction performance unit 330 by dividing the audio spectrum into two types, such as a stable type and a short type, in accordance with the intensity of audio spectrum variations.

In further detail, in an embodiment, if the frequency domain low band signal LB or a result of the frequency linear prediction performance unit 330 is a transient signal, for example, the multi-resolution analysis unit 340 may perform the multi-resolution analysis on the transient signal. That is, the multi-resolution analysis unit 340 may selectively improve the encoding efficiency by performing the multi-resolution analysis in accordance with a characteristic of the received signal.

The quantization unit 350 may quantize a result of the frequency linear prediction performance unit 330 or the multi-resolution analysis unit 340, for example.

In an embodiment, the context-dependent bitplane encoding unit 360 may further perform context-dependent encoding on a result of the quantization unit 350 so as to generate an encoded bitplane. Here, the context-dependent bitplane encoding unit 360 may perform the context-dependent encoding by using a Huffman coding method, for example.

The frequency linear prediction performance unit 330, the multi-resolution analysis unit 340, the quantization unit 350, and the context-dependent bitplane encoding unit 360, in an embodiment, may be considered to collectively encode the frequency domain low band signal LB and thus may be collectively referred to as a low band encoding unit.

Depending on embodiment, the low band conversion unit 370 may convert the low band signal LB, e.g., split by the band splitting unit 310, from the time domain to the frequency domain or the time/frequency domain by using a conversion method other an MDCT method. For example, the low band conversion unit 370 may convert the low band signal LB from the time domain to the frequency domain or the time/frequency domain by using an MDST method, a FFT method, or a QMF method. Here, the time domain represents variations in amplitude such as energy or sound pressure of the low band signal LB according to time, the frequency domain represents variations in amplitude of the low band signal LB according to frequency, and the time/frequency domain represents variations of amplitude of the low band signal LB according to time and frequency.

Similarly, depending on embodiment, the high band conversion unit 375 may convert the high band signal HB, e.g., split by the band splitting unit 310, from the time domain to the frequency domain or the time/frequency domain by using a conversion method other than the MDCT method. Further, for example, the high band conversion unit 375 and the low band conversion unit 370 use the same conversion method. As only an example, the high band conversion unit 375 may use the MDST method, the FFT method, or the QMF method.

The bandwidth extension encoding unit 380 may generate and encode bandwidth extension information that represents a potentially identified characteristic of the frequency domain high band signal HB, e.g., converted to the frequency domain or the time/frequency domain by the high band conversion unit 375, by using the frequency domain low band signal LB, e.g., as converted to the frequency domain or the time/frequency domain by the low band conversion unit 370. Here, it should be understood that the bandwidth extension information may include various pieces of information, such as an energy level and an envelope, of the high band signal HB, for example. In more detail, in an embodiment, the bandwidth extension encoding unit 380 may generate the bandwidth extension information by using information on the low band signal LB based on the fact that strong correlations may exist between the low band signal LB and the high band signal HB. According to another embodiment of the present invention, the bandwidth extension encoding unit 380 may generate the bandwidth extension information by using a result of encoding the low band signal LB, for example.

If the mode determination unit 320 determines to encode the low band signal LB in the time domain, the CELP encoding unit 385 may encode the low band signal LB by using a CELP encoding method, for example. Here, the CELP encoding method is a method of performing linear prediction on the low band signal LB, encoding formant components by filtering the low band signal LB by using calculated coefficients of a linear prediction filter, and encoding pitched components of the filtered signal by searching an adaptive codebook and a fixed codebook.

The multiplexing unit 390 may further generate a bitstream by multiplexing the encoded results of the stereo encoding unit 300, the frequency linear prediction performance unit 330, the context-dependent bitplane encoding unit 360, the bandwidth extension encoding unit 380, and the CELP encoding unit 385 so as to output the bitstream, e.g., as an output signal OUT.

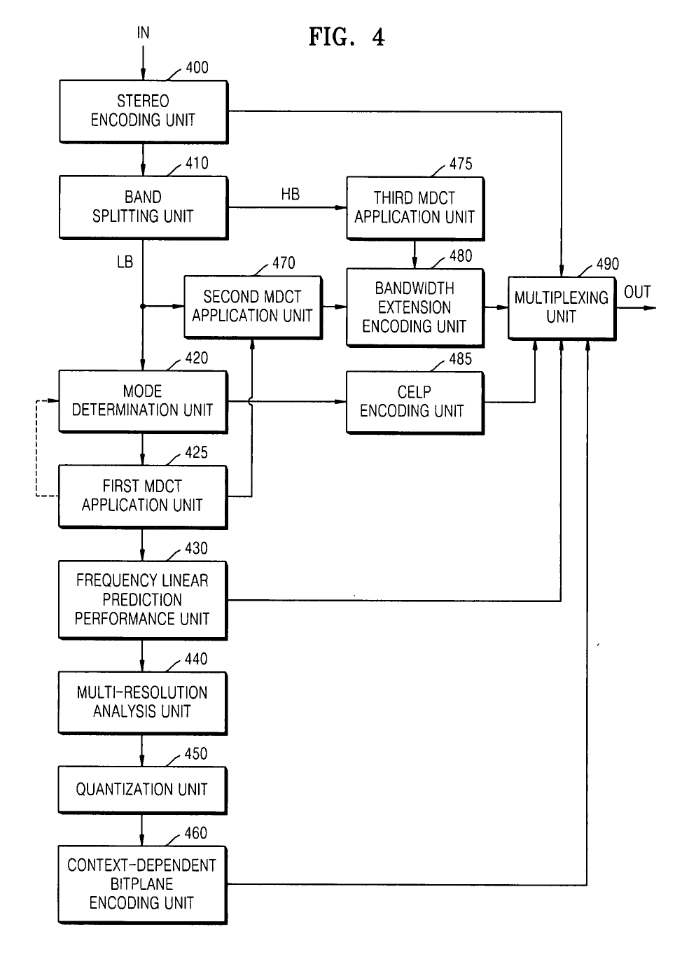

FIG. 4 illustrates a system encoding an audio signal, according to another embodiment of the present invention.

Referring to FIG. 4, the system may include a stereo encoding unit 400, a band splitting unit 410, a mode determination unit 420, a first MDCT application unit 425, a frequency linear prediction performance unit 430, a multi-resolution analysis unit 440, a quantization unit 450, a context-dependent bitplane encoding unit 460, a second MDCT application unit 470, a third MDCT application unit 475, a bandwidth extension encoding unit 480, a CELP encoding unit 485, and a multiplexing unit 490, for example, and may be a single processing element system embodiment through at least a computer system embodiment, including through potentially distributed networks, to achieve the advantages of the present invention not previously available.

The stereo encoding unit 400 may extract stereo, or plural, parameters from an input signal IN, encode the stereo parameters, and perform down-mixing on the input signal IN.

The band splitting unit 410 may split the down-mixed signal into an example low band signal LB and a high band signal HB.

The mode determination unit 420 may determine whether to encode the low band signal LB, e.g., as split by the band splitting unit 410, in the time domain or the frequency domain in accordance with a predetermined standard. For example, the mode determination unit 420 may determine whether to encode the low band signal LB split by the band splitting unit 410 in the time domain or the frequency domain in accordance with a result of the first MDCT application unit 425.

If the mode determination unit 420 determines to encode the low band signal LB in the frequency domain, the first MDCT application unit 425 may perform MDCT on the low band signal LB so as to convert the low band signal LB from the time domain to the frequency domain. Here, again, the time domain represents variations in amplitude such as energy or sound pressure of the low band signal LB according to time and the frequency domain represents variations in amplitude of the low band signal LB according to frequency. Here, as noted, the result of the MDCT may be used by the mode determination unit 420 in order to determine a desired encoding domain.

The frequency linear prediction performance unit 430 may perform frequency linear prediction on the frequency domain low band signal LB. Here, the frequency linear prediction may approximate a current frequency signal to a linear combination of a previous frequency signal. In more detail, in an embodiment, the frequency linear prediction performance unit 430 may calculate coefficients of a linear prediction filter so as to minimize prediction errors that are differences between a linearly predicted signal and the current frequency signal, and perform linear prediction filtering on the frequency domain low band signal LB in accordance with the calculated coefficients. Here, in an embodiment, the frequency linear prediction performance unit 430 may further improve the encoding efficiency by performing vector quantization on corresponding values of coefficients of a linear prediction filter so as to represent the corresponding values by using vector indices.

In further detail, if the frequency domain low band signal is speech or a pitched signal, the frequency linear prediction performance unit 430 may selectively perform the frequency linear prediction on the speech signal or pitched signal, for example. That is, the frequency linear prediction performance unit 430 may further improve the encoding efficiency by selectively performing the frequency linear prediction in accordance with a characteristic of a received signal.

The multi-resolution analysis unit 440 may receive a result of the first MDCT application unit 425 or the frequency linear prediction performance unit 430, for example, and perform multi-resolution analysis on audio spectrum coefficients of the received signal that instantaneously vary. In more detail, in an embodiment, the multi-resolution analysis unit 440 may perform the multi-resolution analysis on an audio spectrum filtered by the frequency linear prediction performance unit 430 by dividing the audio spectrum into two types, such as a stable type and a short type, in accordance with the intensity of audio spectrum variations, for example.

In further detail, in an embodiment, if the frequency domain low band signal LB or a result of the frequency linear prediction performance unit 430 is a transient signal, for example, the multi-resolution analysis unit 440 may selectively perform the multi-resolution analysis on the transient signal. That is, the multi-resolution analysis unit 440 may further improve the encoding efficiency by selectively performing the multi-resolution analysis in accordance with a characteristic of the received signal.

The quantization unit 450 may quantize a result of the frequency linear prediction performance unit 430 or the multi-resolution analysis unit 440, for example.

The context-dependent bitplane encoding unit 460 may further perform context-dependent encoding on a result of the quantization unit 450 so as to generate an encoded bitplane. Here, the context-dependent bitplane encoding unit 460 may perform the context-dependent encoding by using a Huffman coding method, for example.

The frequency linear prediction performance unit 430, the multi-resolution analysis unit 440, the quantization unit 450, and the context-dependent bitplane encoding unit 460, in an embodiment, may be considered to collectively encode the frequency domain low band signal LB and thus may be collectively referred to as a low band encoding unit, for example.

The second MDCT application unit 470 may perform the MDCT on the low band signal LB split by the band splitting unit 410 so as to convert the low band signal LB from the time domain to the frequency domain. If the mode determination unit 420 determines to encode the low band signal LB in the frequency domain, the second MDCT application unit 470 may not perform the MDCT on the low band signal LB. In this case, the result output of second MDCT application unit 470 may be substituted for with the result of the first MDCT application unit 425.

The third MDCT application unit 475 may perform the MDCT on the high band signal HB, e.g., split by the band splitting unit 410, so as to convert the high band signal HB from the time domain to the frequency domain.

The bandwidth extension encoding unit 480 may generate and encode bandwidth extension information that represents a potentially identifiable characteristic of the frequency domain high band signal HB, e.g., converted to the frequency domain by the third MDCT application unit 475, by using the frequency domain low band signal LB, e.g., converted to the frequency domain by the second MDCT application unit 470. Here, it should be understood that the bandwidth extension information may include various pieces of information, such as an energy level and an envelope, of the high band signal HB. In more detail, for example, the bandwidth extension encoding unit 480 may generate the bandwidth extension information by using information on the low band signal LB based on the fact that strong correlations may exist between the low band signal LB and the high band signal HB. According to another embodiment of the present invention, the bandwidth extension encoding unit 480 may generate the bandwidth extension information by using a result of encoding the low band signal LB, for example.

If the mode determination unit 420 determines to encode the low band signal LB in the time domain, the CELP encoding unit 485 may encode the low band signal LB by using the aforementioned CELP encoding method.

The multiplexing unit 490 may further generates a bitstream by multiplexing the encoded results of the stereo encoding unit 400, the frequency linear prediction performance unit 430, the context-dependent bitplane encoding unit 460, the bandwidth extension encoding unit 480, and the CELP encoding unit 485 so as to output the bitstream, e.g., as an output signal OUT.

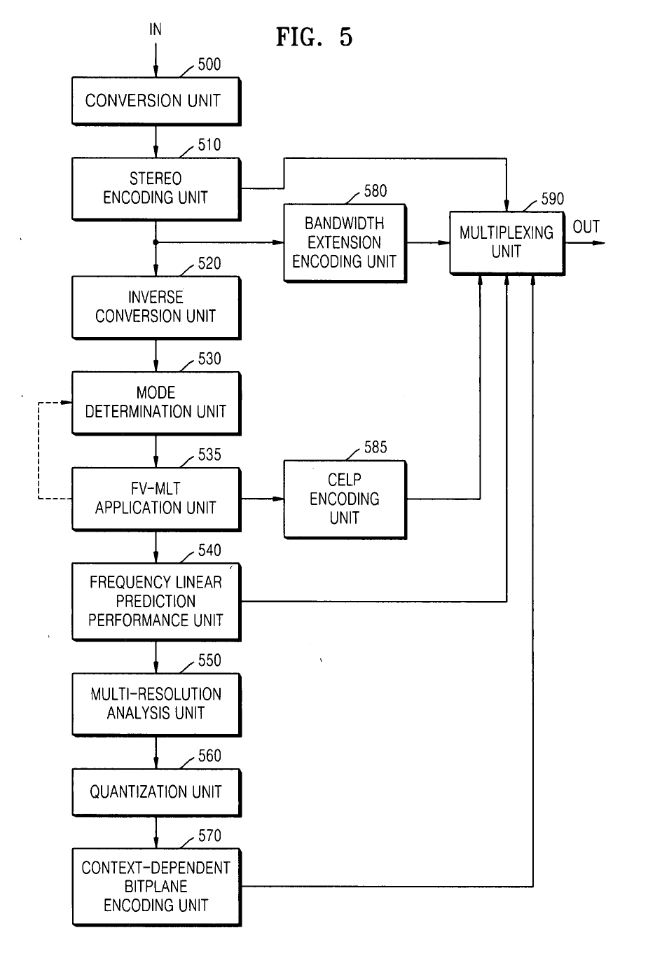

FIG. 5 illustrates a system encoding an audio signal, according to another embodiment of the present invention.

Referring to FIG. 5, the system may include a conversion unit 500, a stereo encoding unit 510, an inverse conversion unit 520, a mode determination unit 530, a frequency varying modulated lapped transformation (FV-MLT) application unit 535, a frequency linear prediction performance unit 540, a multi-resolution analysis unit 550, a quantization unit 560, a context-dependent bitplane encoding unit 570, a bandwidth extension encoding unit 580, a CELP encoding unit 585, and a multiplexing unit 590, for example, and may be a single processing element system embodiment through at least a computer system embodiment, including through potentially distributed networks, to achieve the advantages of the present invention not previously available.

Depending on embodiment, the conversion unit 500 may convert an input signal IN from the time domain to the frequency domain or the time/frequency domain by using a conversion method. For example, the conversion unit 500 may convert the input signal IN by using an MDST method, a FFT method, or a QMF method, noting that alternatives are equally available. For example, an MDCT method may be used. However, if the MDCT method is used, the previous described embodiments of FIGS. 1 through 4 may be more efficient than the use of MDCT in the embodiment of FIG. 5

Here, again, the input signal IN may be a PCM signal in which an analog speech or audio signal is modulated into a digital signal. As noted above, the time domain represents variations in amplitude such as energy or sound pressure of the input signal IN according to time, the frequency domain represents variations in amplitude of the input signal IN according to frequency, and the time/frequency domain represents variations of amplitude of the input signal IN according to time and frequency.

Thus, the stereo encoding unit 510 may extract stereo, or plural, parameters from the converted signal output from the conversion unit 500, encode the stereo parameters, and perform down-mixing on the converted signal.

The inverse conversion unit 520 may inversely convert the down-mixed signal from the frequency domain or the time/frequency domain to the time domain. In an embodiment, the inverse conversion unit 520 may use a method inversely corresponding to the method used by the conversion unit 510. For example, if the conversion unit has used the QMF method, the inverse conversion unit 520 may use an inverse QMF method, noting that alternatives are equally available.

The mode determination unit 530 may determine whether to encode the inversely converted signal, inversely converted by the inverse conversion unit 520, in the time domain or the frequency domain in accordance with a predetermined standard. For example, the mode determination unit 530 may determine whether to encode the inversely converted signal in the time domain or the frequency domain in accordance with the result output from the FV-MLT application unit 535.

The FV-MLT application unit 535 may perform FV-MLT on an input signal, determined whether to be encoded in the time domain or the frequency domain by the mode determination unit 530, so as to convert the determined signal to the time domain or the frequency domain by sub-bands. In more detail, the FV-MLT is a flexible transformation method that can convert a signal represented in the time domain to the frequency domain, appropriately control temporal resolutions of the converted signal by frequency bands, and represent a predetermined sub-band signal in the time domain or the frequency domain. Here, the result of the FV-MLT may be used by the mode determination unit 530 in order to determine the desired encoding domain.

If the mode determination unit 530 determines that it is desirable to encode a signal in the frequency domain, the frequency linear prediction performance unit 540 may perform frequency linear prediction on a signal converted to the frequency domain by the FV-MLT application unit 535. Here, the frequency linear prediction approximates a current frequency signal to a linear combination of a previous frequency signal. In more detail, the frequency linear prediction performance unit 540 may calculate coefficients of a linear prediction filter so as to minimize prediction errors that are differences between a linearly predicted signal and the current frequency signal, and perform linear prediction filtering on the signal converted to the frequency domain in accordance with the calculated coefficients. Here, in an embodiment, the frequency linear prediction performance unit 540 may improve the encoding efficiency by performing vector quantization on corresponding values of coefficients of a linear prediction filter so as to represent the corresponding values by using vector indices.

In further detail, in an embodiment, if the signal converted to the frequency domain by the FV-MLT application unit 535 is speech or a pitched signal, the frequency linear prediction performance unit 540 may selectively perform the frequency linear prediction on the speech signal or pitched signal. That is, the frequency linear prediction performance unit 540 may further improve the encoding efficiency by selectively performing the frequency linear prediction in accordance with a characteristic of a received signal.

The multi-resolution analysis unit 550 may receive a result of the FV-MLT application unit 535 or the frequency linear prediction performance unit 540, for example, and perform multi-resolution analysis on audio spectrum coefficients of the received signal that instantaneously vary. In more detail, in an embodiment, the multi-resolution analysis unit 550 may perform the multi-resolution analysis on an audio spectrum filtered by the frequency linear prediction performance unit 540 by dividing the audio spectrum into two types, such as a stable type and a short type, in accordance with the intensity of audio spectrum variations.

In further detail, in an embodiment, if the signal converted to the frequency domain by the FV-MLT application unit 535 or a result of the frequency linear prediction performance unit 540 is a transient signal, the multi-resolution analysis unit 550 may further selectively perform the multi-resolution analysis on the transient signal. That is, the multi-resolution analysis unit 550 may further improve the encoding efficiency by selectively performing the multi-resolution analysis in accordance with a characteristic of the received signal.

The quantization unit 560 may quantize a result of the frequency linear prediction performance unit 540 or the multi-resolution analysis unit 550, for example.

The context-dependent bitplane encoding unit 570 may perform context-dependent encoding on a result of the quantization unit 560 so as to generate an encoded bitplane. Here, the context-dependent bitplane encoding unit 570 may perform the context-dependent encoding by using a Huffman coding method, for example.

The bandwidth extension encoding unit 580 may extract bandwidth extension information from the down-mixed signal and encode the bandwidth extension information. Here, it should be understood that the bandwidth extension information may include various pieces of information, such as an energy level and an envelope, of the signal, noting that alternatives are further available.

If the mode determination unit 530 determines that it is desirable to encode a signal in the time domain, the CELP encoding unit 585 may encode a signal converted to the time domain by the FV-MLT application unit 535, for example, by using the aforementioned CELP encoding method.

The multiplexing unit 590 may further generate a bitstream by multiplexing encoded results of the stereo encoding unit 510, the frequency linear prediction performance unit 540, the context-dependent bitplane encoding unit 570, the bandwidth extension encoding unit 580, and the CELP encoding unit 585 so as to output the bitstream, e.g., as an output signal OUT.

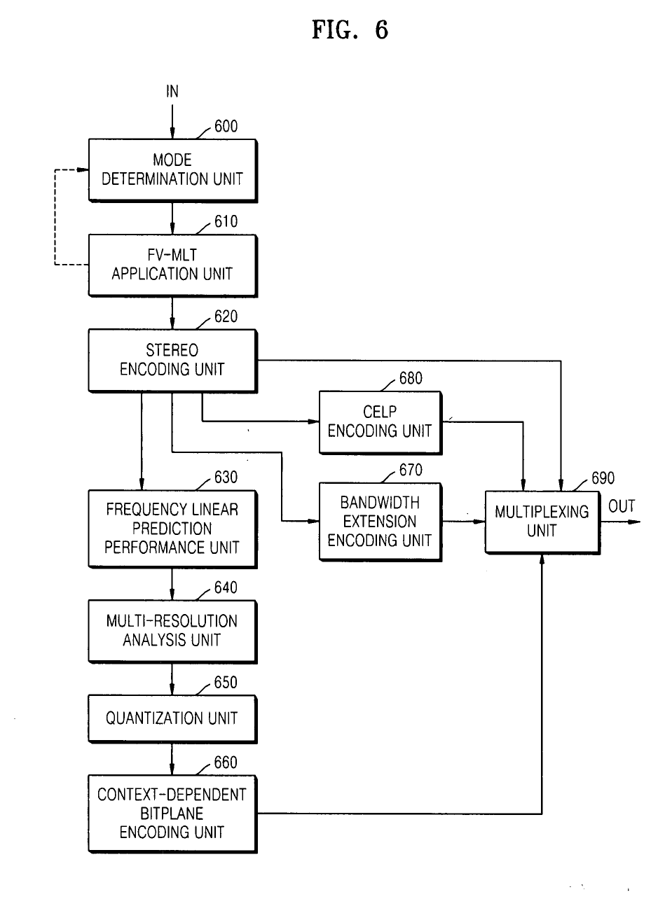

FIG. 6 illustrates a system encoding an audio signal, according to another embodiment of the present invention.

Referring to FIG. 6, the system may include a mode determination unit 600, an FV-MLT application unit 610, a stereo encoding unit 620, a frequency linear prediction performance unit 630, a multi-resolution analysis unit 640, a quantization unit 650, a context-dependent bitplane encoding unit 660, a bandwidth extension encoding unit 670, a CELP encoding unit 680, and a multiplexing unit 690, for example, and may be a single processing element system embodiment through at least a computer system embodiment, including through potentially distributed networks, to achieve the advantages of the present invention not previously available.

The mode determination unit 600 determines whether to encode an input signal IN in the time domain or the frequency domain in accordance with a predetermined standard. Here, again, the input signal IN may be a PCM signal in which an analog speech or audio signal is modulated into a digital signal. For example, the mode determination unit 600 may determine whether to encode the input signal IN in the time domain or the frequency domain, e.g., in accordance with the result output from the FV-MLT application unit 610.

The FV-MLT application unit 610 may, thus, perform FV-MLT on the signal, determined whether to be encoded in the time domain or the frequency domain by the mode determination unit 600, so as to convert the determined signal to the time domain or the frequency domain by frequency sub-bands. In more detail, as noted above, the FV-MLT is a flexible transformation method that can convert a signal represented in the time domain to the frequency domain, appropriately control temporal resolutions of the converted signal by frequency bands, and represent a predetermined sub-band signal in the time domain or the frequency domain. Here, accordingly, a result of the FV-MLT may be used by the mode determination unit 600 in order to determine an encoding domain.

The stereo encoding unit 620 may extract stereo parameters from the converted signal output from the FV-MLT application unit 610, encode the stereo parameters, and perform down-mixing on the converted signal.

If the mode determination unit 600 determines to encode the input signal IN in the frequency domain, the frequency linear prediction performance unit 630 may perform frequency linear prediction on a signal converted to the frequency domain by the FV-MLT application unit 610. Here, again, the frequency linear prediction approximates a current frequency signal to a linear combination of a previous frequency signal. In more detail, the frequency linear prediction performance unit 630 may calculate coefficients of a linear prediction filter so as to minimize prediction errors that are differences between a linearly predicted signal and the current frequency signal, and perform linear prediction filtering on the signal converted to the frequency domain in accordance with the calculated coefficients. In addition, the frequency linear prediction performance unit 630 may improve the encoding efficiency by performing vector quantization on corresponding values of coefficients of a linear prediction filter so as to represent the corresponding values by using vector indices.

In further detail, in an embodiment, if the signal converted to the frequency domain by the FV-MLT application unit 610 is speech or a pitched signal, the frequency linear prediction performance unit 630 may selectively perform the frequency linear prediction on the speech signal or pitched signal. That is, the frequency linear prediction performance unit 630 may further improve the encoding efficiency by selectively performing the frequency linear prediction in accordance with a identified characteristic of a received signal.

The multi-resolution analysis unit 640 may receive a result of the FV-MLT application unit 610 or the frequency linear prediction performance unit 630, for example, and perform multi-resolution analysis on audio spectrum coefficients of the received signal that instantaneously vary. In more detail, in an embodiment, the multi-resolution analysis unit 640 may perform the multi-resolution analysis on an audio spectrum filtered by the frequency linear prediction performance unit 630 by dividing the audio spectrum into two types, such as a stable type and a short type, in accordance with the intensity of audio spectrum variations, for example.

In further detail, in an embodiment, if the signal converted to the frequency domain by the FV-MLT application unit 610 or a result of the frequency linear prediction performance unit 630 is a transient signal, for example, the multi-resolution analysis unit 640 may perform the multi-resolution analysis on the transient signal. That is, the multi-resolution analysis unit 640 may further improve the encoding efficiency by selectively performing the multi-resolution analysis in accordance with a characteristic of the received signal.

The quantization unit 650 may further quantize a result of the frequency linear prediction performance unit 630 or the multi-resolution analysis unit 640.

The context-dependent bitplane encoding unit 660 may then perform context-dependent encoding on a result of the quantization unit 650 so as to generate an encoded bitplane. Here, the context-dependent bitplane encoding unit 660 may perform the context-dependent encoding by using a Huffman coding method, for example, noting again that alternative embodiments are equally available.

The bandwidth extension encoding unit 670 may further extract bandwidth extension information from the down-mixed signal, e.g., as performed by the stereo encoding unit 620, and encode the bandwidth extension information. Here, it should be understood that the bandwidth extension information may include various pieces of information, such as an energy level and an envelope, of the signal, for example.

Still further, if the mode determination unit 600 determines to encode the input signal IN in the time domain, the CELP encoding unit 680 may encode the down-mixed signal by using the aforementioned CELP encoding method.

The multiplexing unit 690 may generate a bitstream by multiplexing the encoded results of the stereo encoding unit 620, the frequency linear prediction performance unit 630, the context-dependent bitplane encoding unit 660, the bandwidth extension encoding unit 670, and the CELP encoding unit 680 so as to output the bitstream, e.g., as an output signal OUT.

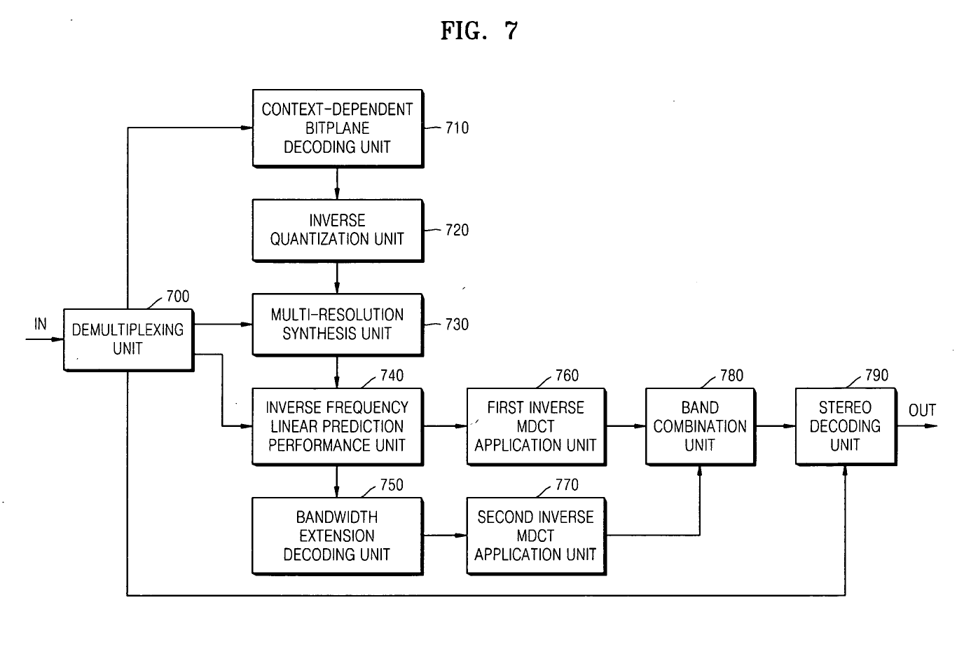

FIG. 7 illustrates a system decoding an audio signal, according to an embodiment of the present invention.

Referring to FIG. 7, the system may include a demultiplexing unit 700, a context-dependent bitplane decoding unit 710, an inverse quantization unit 720, a multi-resolution synthesis unit 730, an inverse frequency linear prediction performance unit 740, a bandwidth extension decoding unit 750, a first inverse MDCT application unit 760, a second inverse MDCT application unit 770, a band combination unit 780, and a stereo decoding unit 790, for example, and may be a single processing element system embodiment through at least a computer system embodiment, including through potentially distributed networks, to achieve the advantages of the present invention not previously available.

The demultiplexing unit 700 may receive and demultiplex a bitstream, such as a bitstream currently or previously output from an encoding terminal. Here, information output from the demultiplexing unit 700 may include analysis information on an audio spectrum, quantization values and other reconstruction information, reconstruction information of a quantization spectrum, information on context-dependant bitplane decoding, signal type information, information on frequency linear prediction and vector quantization, encoded bandwidth extension information, and/or encoded stereo parameters, for example, noting that additional information may also be included as desired.

The context-dependent bitplane decoding unit 710 may perform context-dependent decoding on an encoded bitplane. Here, the context-dependent bitplane decoding unit 710 may receive information from the demultiplexing unit 700 and reconstruct a frequency spectrum, coding band mode information, and a scale factor by using a Huffman coding method, for example. In more detail, in an embodiment, the context-dependent bitplane decoding unit 710 may receive prejudice coding band mode information, a scale factor of prejudice coding, and a frequency spectrum of prejudice coding, and output coding band mode values, a decoding cosmetic indication of the scale factor, and quantization values of the frequency spectrum, for example.

The inverse quantization unit 720 may inversely quantize a result of the context-dependent bitplane decoding unit 710.

The multi-resolution synthesis unit 730 may receive a result of the inverse quantization unit 720 and perform multi-resolution synthesis on audio spectrum coefficients of the received signal that instantaneously vary. In more detail, in an embodiment, the multi-resolution synthesis unit 730 may improve the decoding efficiency by performing the multi-resolution synthesis on a result of the inverse quantization unit 720 if multi-resolution analysis has been performed on an audio signal received from the encoding terminal. Here, the multi-resolution synthesis unit 730 may receive an inverse quantization spectrum/difference spectrum and output a reconstruction spectrum/difference spectrum.

The inverse frequency linear prediction performance unit 740 may combine a result of the multi-resolution synthesis unit 730 and a result of frequency linear prediction by the encoding terminal, as received from the demultiplexing unit 700, for example. In more detail, if frequency linear prediction has been performed on the audio signal received from the encoding terminal, the inverse frequency linear prediction performance unit 740 may be used to improve the decoding efficiency by combining the result of the frequency linear prediction and the result output from the inverse quantization unit 720 or the multi-resolution synthesis unit 730. Here, the inverse frequency linear prediction performance unit 740 may efficiently improve the decoding efficiency by employing a frequency domain prediction technology and a vector quantization technology of prediction coefficients. The inverse frequency linear prediction performance unit 740 may further receive difference spectrum coefficients and vector indices and output MDCT spectrum coefficients and a low band signal.

The bandwidth extension decoding unit 750 may then decode the encoded bandwidth extension information, e.g., as received from the demultiplexing unit 700, and generate a high band signal from the low band signal output from the inverse frequency linear prediction performance unit 740 by using the decoded bandwidth extension information. Here, in an embodiment, the bandwidth extension decoding unit 750 may generate the high band signal by applying the decoded bandwidth extension information to the low band signal based on the fact, or a determination of whether, that strong correlations may exist between the low band signal and the high band signal. Here, the bandwidth extension information may represent a characteristic of the high band signal and include various pieces of information, such as an energy level and an envelope, of the high band signal, for example.

The first inverse MDCT application unit 760 may perform an appropriate inverse operation of the conversion as performed by the originating encoding terminal, for example. The first inverse MDCT application unit 760, thus, may perform inverse MDCT on the low band signal output from the inverse frequency linear prediction performance unit 740 so as to inversely convert the low band signal from the frequency domain to the time domain. Here, the first inverse MDCT application unit 760 may receive frequency spectrum coefficients obtained from a result of inverse quantization by the inverse frequency linear prediction performance unit 740 and may output reconstructed audio data that corresponds to a low band.

The second inverse MDCT application unit 770 may perform inverse MDCT on the high band signal decoded by the bandwidth extension decoding unit 750 so as to inversely convert the high band signal from the frequency domain to the time domain.

The band combination unit 780 may further combine the time domain low band signal, e.g., as inversely converted to the time domain by the first inverse MDCT application unit 760, and the time domain high band signal, e.g., as inversely converted to the time domain by the second inverse MDCT application unit 770.

The stereo decoding unit 790 may then decode the encoded stereo parameters received from the demultiplexing unit 700 and perform up-mixing on the combined signal output from the band combination unit 780 by using the decoded stereo parameters so as to output the result, e.g., as an output signal OUT. Here, the up-mixing can be considered an inverse collapsing operation of down-mixing and is a process of generating a signal having two or more channels from a signal, such as a mono signal having a single channel.

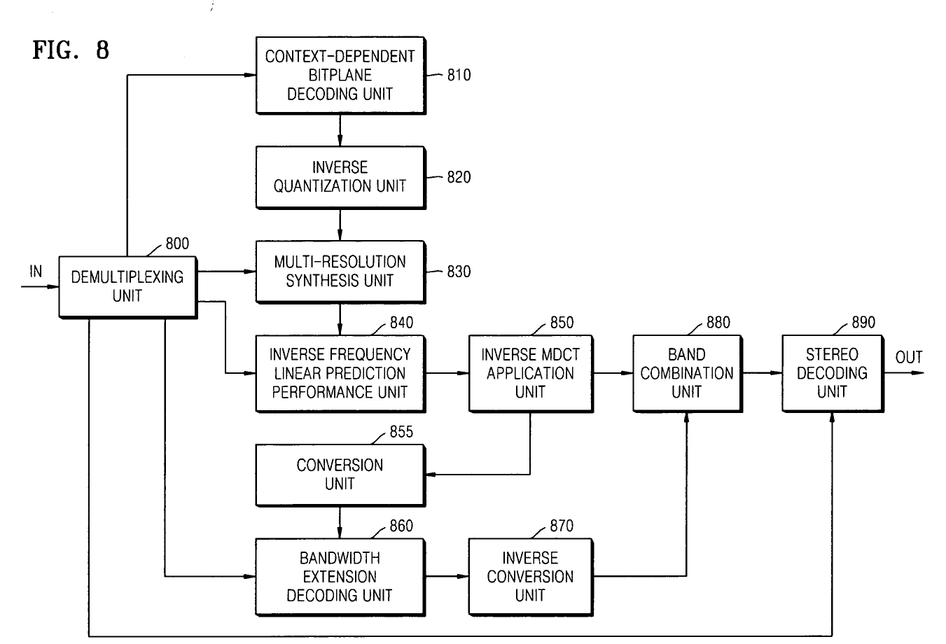

FIG. 8 illustrates a system decoding an audio signal, according to another embodiment of the present invention.

Referring to FIG. 8, the system may include a demultiplexing unit 800,.a context-dependent bitplane decoding unit 810, an inverse quantization unit 820, a multi-resolution synthesis unit 830, an inverse frequency linear prediction performance unit 840, an inverse MDCT application unit 850, a conversion unit 855, a bandwidth extension decoding unit 860, an inverse conversion unit 870, a band combination unit 880, and a stereo decoding unit 890, for example, and may be a single processing element system embodiment through at least a computer system embodiment, including through potentially distributed networks, to achieve the advantages of the present invention not previously available.

The demultiplexing unit 800 may receive and demultiplex a bitstream, e.g., as generated by an encoding terminal, as noted above. In more detail, the demultiplexing unit 800 may split the bitstream into data pieces corresponding to various data levels, and analyze and output information of the bitstream with regard to the data pieces. Here, again, information output from the demultiplexing unit 800 may include analysis information on an audio spectrum, quantization values and other reconstruction information, reconstruction information of a quantization spectrum, information on context-dependant bitplane decoding, signal type information, information on frequency linear prediction and vector quantization, encoded bandwidth extension information, and encoded stereo parameters, for example.

The context-dependent bitplane decoding unit 810 may perform context-dependent decoding on an encoded bitplane. Here, the context-dependent bitplane decoding unit 810 may receive information from the demultiplexing unit 800 and reconstruct a frequency spectrum, coding band mode information, and a scale factor by using a Huffman coding method, for example. In more detail, in an embodiment, the context-dependent bitplane decoding unit 810 may receive prejudice coding band mode information, a scale factor of prejudice coding, and a frequency spectrum of prejudice coding, and output coding band mode values, a decoding cosmetic indication of the scale factor, and quantization values of the frequency spectrum, for example.

The inverse quantization unit 820 may inversely quantize a result of the context-dependent bitplane decoding unit 810.

The multi-resolution synthesis unit 830 may receive a result of the inverse quantization unit 820 and perform multi-resolution synthesis on audio spectrum coefficients of the received signal that instantaneously vary. In more detail, the multi-resolution synthesis unit 830 may improve the decoding efficiency by performing the multi-resolution synthesis on a result of the inverse quantization unit 820 if multi-resolution analysis has been previously performed on an audio signal. Here, the multi-resolution synthesis unit 830 may receive an inverse quantization spectrum/difference spectrum and output a reconstruction spectrum/difference spectrum.

The inverse frequency linear prediction performance unit 840 may combine a result of the multi-resolution synthesis unit 830 and a result of frequency linear prediction, e.g., by the encoding terminal and as received from the demultiplexing unit 800, and perform inverse vector quantization on the combined result. In more detail, in an embodiment, if frequency linear prediction had been performed on the audio signal, the inverse frequency linear prediction performance unit 840 may improve the decoding efficiency by combining the result of the frequency linear prediction and a result of the inverse quantization unit 820 or the multi-resolution synthesis unit 830, for example. Here, in an embodiment, the inverse frequency linear prediction performance unit 840 may efficiently improve the decoding efficiency by employing a frequency domain prediction technology and a vector quantization technology of prediction coefficients. In an embodiment, the inverse frequency linear prediction performance unit 840 may, thus, receive difference spectrum coefficients and vector indices and output MDCT spectrum coefficients and output a low band signal.

The inverse MDCT application unit 850 may further perform inverse MDCT on the low band signal output from the inverse frequency linear prediction performance unit 840 so as to inversely convert the low band signal from the frequency domain to the time domain. Here, the inverse MDCT application unit 850 may receive frequency spectrum coefficients obtained from the result of inverse quantization by the inverse frequency linear prediction performance unit 840 and output reconstructed audio data that corresponds to a low band.

The conversion unit 855 may convert the low band signal, inversely converted to the time domain by the inverse MDCT application unit 850, from the time domain to the frequency domain or the time/frequency domain by using a conversion method. For example, the conversion unit 855 may convert the low band signal by using an MDST method, a FFT method, or a QMF method, only as an example. Further, an MDCT method may also be used. However, in this case, if the MDCT method is used, the operation of the embodiment for FIG. 7 may be more efficient.

The bandwidth extension decoding unit 860 may decode the encoded bandwidth extension information output from the demultiplexing unit 800 and generate a high band signal from the converted low band signal, as converted to the frequency domain or the time/frequency domain by the conversion unit 855, by using the decoded bandwidth extension information, for example. Here, in an embodiment, the bandwidth extension decoding unit 860 may generate the high band signal by applying the decoded bandwidth extension information to the low band signal based on the fact that strong correlations may exist between the low band signal and the high band signal. Here, the bandwidth extension information may represent a characteristic of the high band signal and includes various pieces of information, such as an energy level and an envelope, of the high band signal, for example.

In differing embodiments, the inverse conversion unit 870 may then inversely convert the high band signal decoded by the bandwidth extension decoding unit 860 from the frequency domain or the time/frequency domain to the time domain by using a conversion method other than the MDCT method, for example. Here, the conversion unit 855 and the inverse conversion unit 870 may use the same conversion method. For example, the inverse conversion unit 870 may use the MDST method, the FFT method, or the QMF method, again noting that alternative embodiments are equally available.

The band combination unit 880 may thereafter combine the time domain low band signal, e.g., inversely converted to the time domain by the inverse MDCT application unit 850, and the time domain high band signal, e.g., inversely converted to the time domain by the inverse conversion unit 870.

The stereo decoding unit 890 then may decode the encoded stereo parameters output from the demultiplexing unit 800 and perform up-mixing on the combined signal output from the band combination unit 880 by using the decoded stereo parameters so as to output the result, e.g., as an output signal OUT.

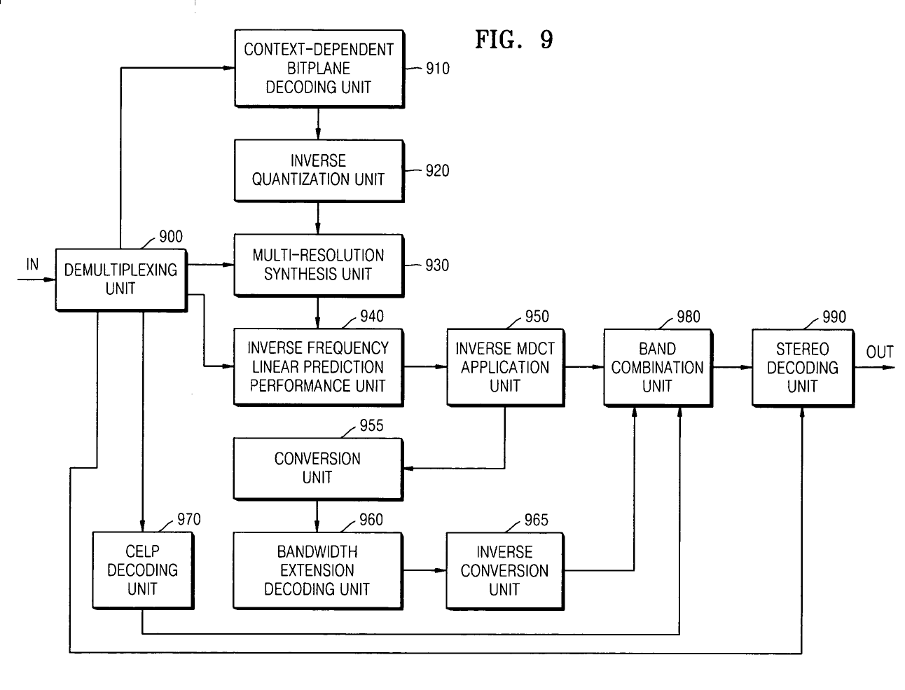

FIG. 9 illustrates a system decoding an audio signal, according to another embodiment of the present invention.

Referring to FIG. 9, the system may include a demultiplexing unit 900, a context-dependent bitplane decoding unit 910, an inverse quantization unit 920, a multi-resolution synthesis unit 930, an inverse frequency linear prediction performance unit 940, an inverse MDCT application unit 950, a conversion unit 955, a bandwidth extension decoding unit 960, an inverse conversion unit 965, a CELP decoding unit 970, a band combination unit 980, and a stereo decoding unit 990, for example, and may be a single processing element system embodiment through at least a computer system embodiment, including through potentially distributed networks, to achieve the advantages of the present invention not previously available.

The demultiplexing unit 900 may receive and demultiplex a bitstream, e.g., as generated by an encoding terminal. In more detail, the demultiplexing unit 900 may split the bitstream into data pieces corresponding to various data levels, and analyze and output information of the bitstream with regard to the data pieces. Here, the information output from the demultiplexing unit 900 may include analysis information on an audio spectrum, quantization values and other reconstruction information, reconstruction information of a quantization spectrum, information on context-dependant bitplane decoding, signal type information, information on frequency linear prediction and vector quantization, encoded bandwidth extension information, CELP encoding information, and encoded stereo parameters, for example.

If the demultiplexed result of the demultiplexing unit 900 indicates or is identifiable as having been encoded in the frequency domain, the context-dependent bitplane decoding unit 910 may perform context-dependent decoding on an encoded bitplane. Here, the context-dependent bitplane decoding unit 910 may receive information output from the demultiplexing unit 900 and reconstruct a frequency spectrum, coding band mode information, and a scale factor by using a Huffman coding method, for example. In more detail, in an embodiment, the context-dependent bitplane decoding unit 910 may receive prejudice coding band mode information, a scale factor of prejudice coding, and a frequency spectrum of prejudice coding, and output coding band mode values, a decoding cosmetic indication of the scale factor, and quantization values of the frequency spectrum, for example.

The inverse quantization unit 920 may inversely quantizes a result of the context-dependent bitplane decoding unit 910.

The multi-resolution synthesis unit 930 may receive a result of the inverse quantization unit 920 and perform multi-resolution synthesis on audio spectrum coefficients of the received signal that instantaneously vary, for example. In more detail, in an embodiment, the multi-resolution synthesis unit 930 may improve the decoding efficiency by performing the multi-resolution synthesis on a result of the inverse quantization unit 920 if multi-resolution analysis had been performed on an audio signal, e.g., by an originating encoding terminal. Here, the multi-resolution synthesis unit 930 may receive an inverse quantization spectrum/difference spectrum and output a reconstruction spectrum/difference spectrum.

The inverse frequency linear prediction performance unit 940 may combine a result of the multi-resolution synthesis unit 930 and a result of frequency linear prediction by the encoding terminal, e.g., as received from the demultiplexing unit 900, and perform inverse vector quantization on the combined result. In more detail, for example, if frequency linear prediction had been performed on the audio signal, the inverse frequency linear prediction performance unit 940 may improve the decoding efficiency by combining a result of the frequency linear prediction and a result of the inverse quantization unit 920 or the multi-resolution synthesis unit 930. Here, in an embodiment, the inverse frequency linear prediction performance unit 940 may, thus, efficiently improve the decoding efficiency by employing a frequency domain prediction technology and a vector quantization technology of prediction coefficients. The inverse frequency linear prediction performance unit 940 may receive difference spectrum coefficients and vector indices and output MDCT spectrum coefficients and a low band signal.

The inverse MDCT application unit 950 may perform inverse MDCT on a low band signal output from the inverse frequency linear prediction performance unit 940 so as to inversely convert the low band signal from the frequency domain to the time domain. Here, for example, the inverse MDCT application unit 950 may receive frequency spectrum coefficients obtained from a result of inverse quantization by the inverse frequency linear prediction performance unit 940 and output reconstructed audio data that corresponds to a low band.

The conversion unit 955 may further convert the low band signal, inversely converted to the time domain by the inverse MDCT application unit 950, from the time domain to the frequency domain or the time/frequency domain by using a conversion method. For example, the conversion unit 955 may convert the time domain low band signal by using an MDST method, a FFT method, or a QMF method, for example. Again, an MDCT method may also be used, but, at least in this embodiment, if the MDCT method is used, the embodiment of FIG. 7 may be more efficient than the current embodiment.

The bandwidth extension decoding unit 960 may decode the encoded bandwidth extension information, e.g., output from the demultiplexing unit 900, and generate a high band signal from the frequency domain low band signal, e.g., as converted to the frequency domain or the time/frequency domain by the conversion unit 955, by using the decoded bandwidth extension information. Here, the bandwidth extension decoding unit 960 may generate the high band signal by applying the decoded bandwidth extension information to the low band signal based on a fact that strong correlations may exist between the low band signal and the high band signal. Here, the bandwidth extension information may represent a characteristic of the high band signal and include various pieces of information, such as an energy level and an envelope, of the high band signal, for example.

In an embodiment, the inverse conversion unit 965 may inversely convert the high band signal, e.g., as decoded by the bandwidth extension decoding unit 960, from the frequency domain or the time/frequency domain to the time domain, by using a conversion method other than the MDCT method. Similar to above, the conversion unit 955 and the inverse conversion unit 965 may use the same conversion method. For example, the inverse conversion unit 965 may use the MDST method, the FFT method, or the QMF method.

If the demultiplexed result of the demultiplexing unit 900 is encoded in the time domain, the CELP decoding unit 970 may be used to decode the CELP encoding information by using an appropriate CELP decoding method so as to generate the low band signal. Similar to above, the CELP decoding method is a method of restoring an encoded signal by using the indexes and gains of the fixed codebook, and the delays and gains of the adaptive codebook, combining the restored signal by using the coefficients of the linear prediction filter, and decoding a signal encoded by using the aforementioned CELP encoding method.

The band combination unit 980 may combine the time domain low band signal, e.g., as output from the inverse MDCT application unit 950, and the time domain high band signal, e.g., as inversely converted by the inverse conversion unit 965, and the signal decoded by the CELP decoding unit 970.

The stereo decoding unit 990 may then decode the encoded stereo parameters output from the demultiplexing unit 900 and perform up-mixing on the combined signal output from the band combination unit 980 by using the decoded stereo parameters so as to output the result, e.g., as an output signal OUT.

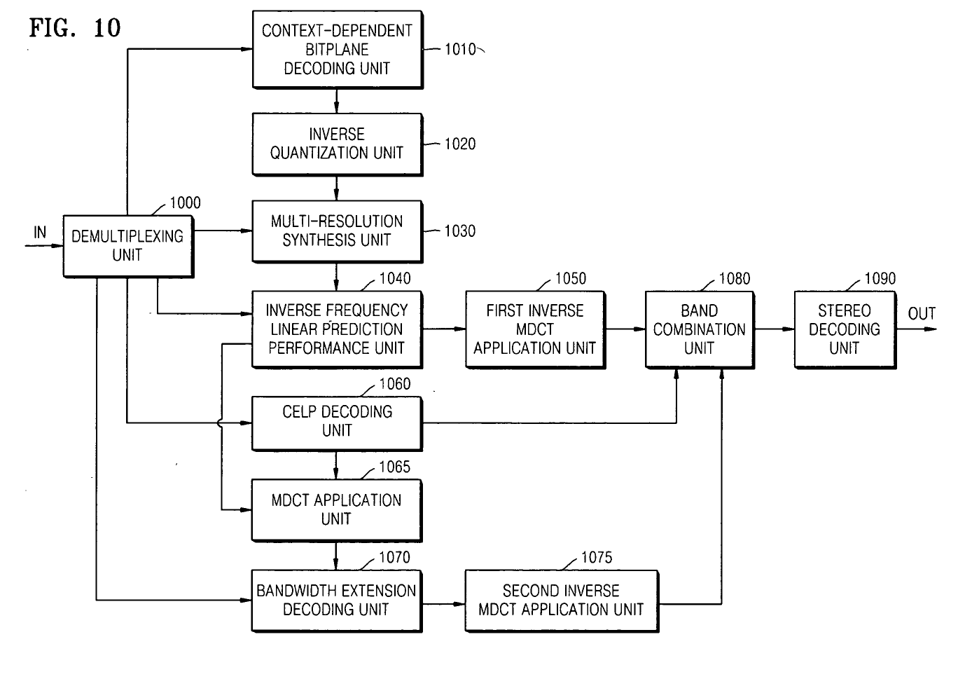

FIG. 10 illustrates a system decoding an audio signal, according to another embodiment of the present invention.

Referring to FIG. 10, the system may include a demultiplexing unit 1000, a context-dependent bitplane decoding unit 1010, an inverse quantization unit 1020, a multi-resolution synthesis unit 1030, an inverse frequency linear prediction performance unit 1040, a first inverse MDCT application unit 1050, a CELP decoding unit 1060, an MDCT application unit 1065, a bandwidth extension decoding unit 1070, a second inverse MDCT application unit 1075, a band combination unit 1080, and a stereo decoding unit 1090, for example, and may be a single processing element system embodiment through at least a computer system embodiment, including through potentially distributed networks, to achieve the advantages of the present invention not previously available.

The demultiplexing unit 1000 may receive and demultiplex a bitstream, e.g., as generated by an encoding terminal. In more detail, the demultiplexing unit 1000 may split the bitstream into data pieces corresponding to various data levels, and analyze and output information of the bitstream with regard to the data pieces. Here, the information output from the demultiplexing unit 1000 may include analysis information on an audio spectrum, quantization values and other reconstruction information, reconstruction information of a quantization spectrum, information on context-dependant bitplane decoding, signal type information, information on frequency linear prediction and vector quantization, encoded bandwidth extension information, CELP encoding information, and encoded stereo parameters, for example.

If the demultiplexed result of the demultiplexing unit 1000 indicates or is identifiable as having been encoded in the frequency domain, the context-dependent bitplane decoding unit 1010 may perform context-dependent decoding on an encoded bitplane. Here, the context-dependent bitplane decoding unit 1010 may receive information output from the demultiplexing unit 1000 and reconstruct a frequency spectrum, coding band mode information, and a scale factor by using a Huffman coding method, for example. In more detail, in an embodiment, the context-dependent bitplane decoding unit 1010 may receive prejudice coding band mode information, a scale factor of prejudice coding, and a frequency spectrum of prejudice coding, and output coding band mode values, a decoding cosmetic indication of the scale factor, and quantization values of the frequency spectrum, for example.

The inverse quantization unit 1020 may inversely quantize a result of the context-dependent bitplane decoding unit 1010.

The multi-resolution synthesis unit 1030 may then receive a result of the inverse quantization unit 1020 and perform multi-resolution synthesis on audio spectrum coefficients of the received signal that instantaneously vary, for example. In more detail, in an embodiment, the multi-resolution synthesis unit 1030 may improve the decoding efficiency by selectively performing the multi-resolution synthesis on the result of the inverse quantization unit 1020 if multi-resolution analysis had been performed on an audio signal, e.g., during encoding. Here, the multi-resolution synthesis unit 1030 may receive an inverse quantization spectrum/difference spectrum and output a reconstruction spectrum/difference spectrum.

The inverse frequency linear prediction performance unit 1040 may combine the result of the multi-resolution synthesis unit 1030 and a result of frequency linear prediction by the encoding terminal, e.g., as received from the demultiplexing unit 1000. In more detail, if frequency linear prediction had been performed on the audio signal, e.g., during encoding, the inverse frequency linear prediction performance unit 1040 may improve the decoding efficiency by combining a result of the frequency linear prediction and a result of the inverse quantization unit 1020 or the multi-resolution synthesis unit 1030, for example. Here, in an embodiment, the inverse frequency linear prediction performance unit 1040 may efficiently improve the decoding efficiency by employing a frequency domain prediction technology and a vector quantization technology of prediction coefficients. The inverse frequency linear prediction performance unit 1040 may receive difference spectrum coefficients and vector indices and output MDCT spectrum coefficients and a low band signal.

The first inverse MDCT application unit 1050 may perform inverse MDCT on the signal output from the inverse frequency linear prediction performance unit 1040 so as to inversely convert the signal from the frequency domain to the time domain. Here, the first inverse MDCT application unit 1050 receives frequency spectrum coefficients obtained from the result of inverse quantization by the inverse frequency linear prediction performance unit 1040 and outputs reconstructed audio data that corresponds to a low band.

If the demultiplexed result of the demultiplexing unit 1000 had been encoded in the time domain, the CELP decoding unit 1060 may be used to decode the CELP encoding information by using the aforementioned CELP decoding method so as to generate the low band signal.

Here, further, if the demultiplexed result of the demultiplexing unit 1000 had been encoded in the time domain, the MDCT application unit 1065 may perform MDCT on the low band signal decoded by the CELP decoding unit 1060 so as to convert the low band signal from the time domain to the frequency domain. If a demultiplexed result of the demultiplexing unit 1000 had been encoded in the frequency domain, the MDCT application unit 1065 may not perform the MDCT on the low band signal. In this case, the resultant output of the MDCT application unit 1065 may be substituted with the resultant output of the inverse frequency linear prediction performance unit 1040.

The bandwidth extension decoding unit 1070 may decode the encoded bandwidth extension information, e.g., as output from the demultiplexing unit 1000, and generate a high band signal from the low band signal output from the MDCT application unit 1065 by using the decoded bandwidth extension information. Here, the bandwidth extension decoding unit 1070 may generate the high band signal by applying the decoded bandwidth extension information to the low band signal based on the fact that strong correlations may exist between the low band signal and the high band signal. Here, the bandwidth extension information may represent a characteristic of the high band signal and include various pieces of information, such as an energy level and an envelope, of the high band signal, for example.

The second inverse MDCT application unit 1075 may perform the inverse MDCT on the high band signal, as decoded by the bandwidth extension decoding unit 1070, so as to inversely convert the high band signal from the frequency domain to the time domain.

The band combination unit 1080 may further combine the time domain low band signal, as inversely converted to the time domain by the first inverse MDCT application unit 1050, and the time domain high band signal, as inversely converted to the time domain by the second inverse MDCT application unit 1075.

The stereo decoding unit 1090 may further decode the encoded stereo parameters output from the demultiplexing unit 1000 and perform up-mixing on the combined signal output from the band combination unit 1080 by using the decoded stereo parameters so as to output the result, e.g., as an output signal OUT.

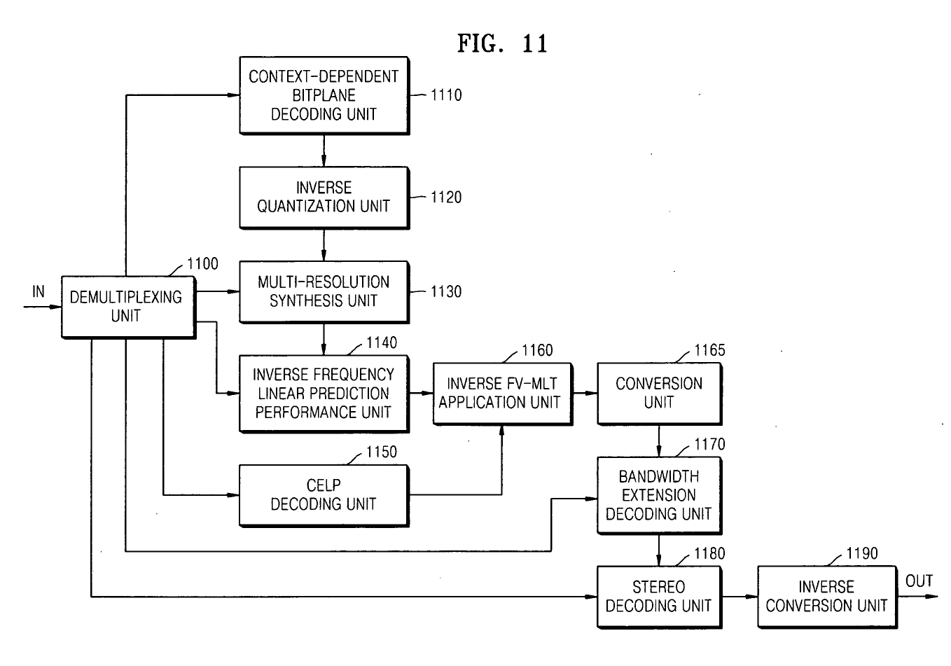

FIG. 11 illustrates a system decoding an audio signal, according to another embodiment of the present invention.

Referring to FIG. 11, the system may include a demultiplexing unit 1100, a context-dependent bitplane decoding unit 1110, an inverse quantization unit 1120, a multi-resolution synthesis unit 1130, an inverse frequency linear prediction performance unit 1140, a CELP decoding unit 1150, an inverse FV-MLT application unit 1160, a conversion unit 1165, a bandwidth extension decoding unit 1170, a stereo decoding unit 1180, and an inverse conversion unit 1190, for example, and may be a single processing element system embodiment through at least a computer system embodiment, including through potentially distributed networks, to achieve the advantages of the present invention not previously available.

The demultiplexing unit 1100 may receive and demultiplex a bitstream, e.g., as generated by an encoding terminal. The demultiplexing unit 1100 may split the bitstream into data pieces corresponding to various data levels, and analyze and output information of the bitstream with regard to the data pieces. Here, the information output from the demultiplexing unit 1100 may include analysis information on an audio spectrum, quantization values and other reconstruction information, reconstruction information of a quantization spectrum, information on context-dependant bitplane decoding, signal type information, information on frequency linear prediction and vector quantization, CELP encoding information, encoded bandwidth extension information, and encoded stereo parameters, for example.

If the demultiplexed result of the demultiplexing unit 1100 indicates or is identifiable as having been encoded in the frequency domain, the context-dependent bitplane decoding unit 1110 may perform context-dependent decoding on an encoded bitplane. Here, the context-dependent bitplane decoding unit 1110 may receive the information output from the demultiplexing unit 1100 and reconstruct a frequency spectrum, coding band mode information, and a scale factor by using a Huffman coding method, for example. In more detail, in an embodiment, the context-dependent bitplane decoding unit 1110 may receive prejudice coding band mode information, a scale factor of prejudice coding, and a frequency spectrum of prejudice coding, and output coding band mode values, a decoding cosmetic indication of the scale factor, and quantization values of the frequency spectrum, for example.

The inverse quantization unit 1120 may further inversely quantize a result of the context-dependent bitplane decoding unit 1110.

The multi-resolution synthesis unit 1130 may receive a result of the inverse quantization unit 1120 and perform multi-resolution synthesis on audio spectrum coefficients of the received signal that instantaneously vary, for example. In more detail, the multi-resolution synthesis unit 1130 may improve the decoding efficiency by performing the multi-resolution synthesis on a result of the inverse quantization unit 1120 if multi-resolution analysis had been performed on an audio signal, e.g., as originally encoded. Here, the multi-resolution synthesis unit 1130 may receive an inverse quantization spectrum/difference spectrum and output a reconstruction spectrum/difference spectrum.

The inverse frequency linear prediction performance unit 1140 may combine a result of the multi-resolution synthesis unit 1130 and a result of frequency linear prediction by the encoding terminal, e.g., as received from the demultiplexing unit 1100, and perform inverse vector quantization on the combined result. In more detail, in an embodiment, if frequency linear prediction had been performed on the audio signal, the inverse frequency linear prediction performance unit 1140 may improve the decoding efficiency by combining the result of the frequency linear prediction and the result of the inverse quantization unit 1120 or the multi-resolution synthesis unit 1130. Here, the inverse frequency linear prediction performance unit 1140 may, thus, efficiently improve the decoding efficiency by employing a frequency domain prediction technology and a vector quantization technology of prediction coefficients, for example. The inverse frequency linear prediction performance unit 1140 may receive difference spectrum coefficients and vector indices and output MDCT spectrum coefficients.

If the demultiplexed result of the demultiplexing unit 1100 indicates or is identifiable as having been encoded in the time domain, the CELP decoding unit 1150 may decode the CELP encoding information.

The inverse FV-MLT application unit 1160 may perform inverse FV-MLT on the signal output from the inverse frequency linear prediction performance unit 1140 so as to inversely convert the signal from the frequency domain to the time domain and combine the signal inversely converted to the time domain and the signal output from the CELP decoding unit 1150 so as to output the combined signal converted to the time domain.

The conversion unit 1165 may convert the signal inversely converted to the time domain by the inverse FV-MLT application unit 1160 from the time domain to the frequency domain or the time/frequency domain by using a conversion method. For example, similar to above, the conversion unit 1165 may convert the low band signal by using an MDST method, a FFT method, or a QMF method. In addition, an MDCT method can also be used, but, if the MDCT method is used, the embodiment shown FIG. 10 may be more efficient.

The bandwidth extension decoding unit 1170 may decode the encoded bandwidth extension information, e.g., as output from the demultiplexing unit 1100, and generate a full band signal from the signal converted to the frequency domain or the time/frequency domain by the conversion unit 1165 by using the decoded bandwidth extension information. Here, in an embodiment, the bandwidth extension decoding unit 1170 may generate the full band signal by applying the decoded bandwidth extension information to the signal output from the conversion unit 1165 based on the fact that strong correlations may exist between a low band signal and a high band signal. Here, the bandwidth extension information may represent a characteristic of the high band signal and include various pieces of information, such as an energy level and an envelope, of the high band signal, for example.

The stereo decoding unit 1180 may decode the encoded stereo parameters, e.g., as output from the demultiplexing unit 1100, and perform up-mixing on the signal output from the bandwidth extension decoding unit 1170 by using the decoded stereo parameters.

Through differing embodiments, the inverse conversion unit 1190 may then further inversely convert the up-mixed signal from the frequency domain or the time/frequency domain to the time domain by using a conversion method other than the MDCT method so as to output the result, e.g., as an output signal OUT. Here, the conversion unit 1165 and the inverse conversion unit 1190 may also use the same conversion method. For example, the inverse conversion unit 1190 may use the MDST method, the FFT method, or the QMF method, noting again that alternate embodiments are equally available.

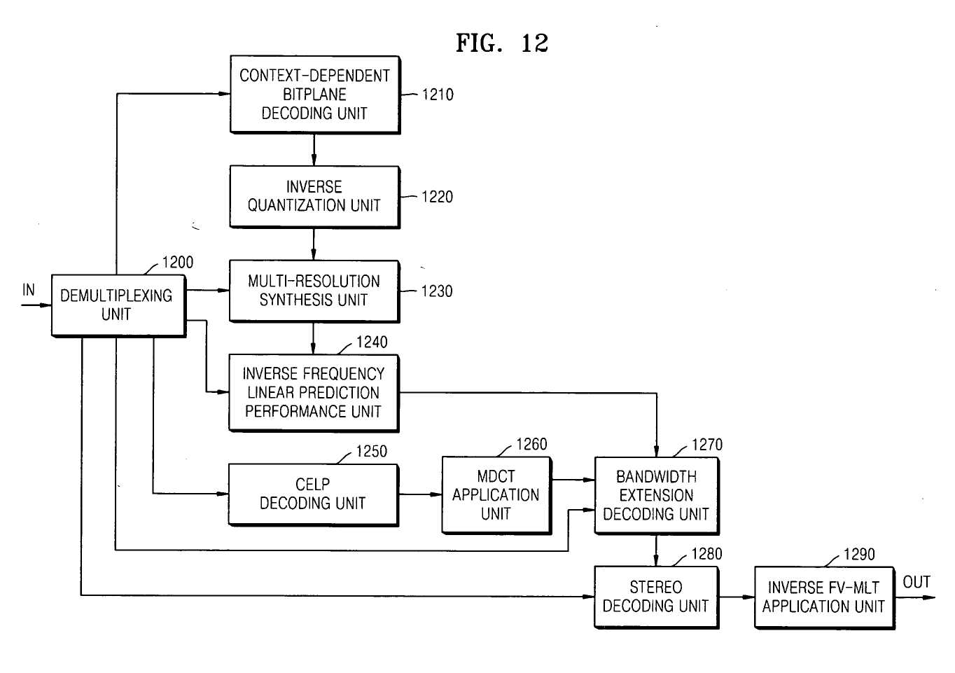

FIG. 12 illustrates a system decoding an audio signal, according to another embodiment of the present invention.

Referring to FIG. 12, the system may include a demultiplexing unit 1200, a context-dependent bitplane decoding unit 1210, an inverse quantization unit 1220, a multi-resolution synthesis unit 1230, an inverse frequency linear prediction performance unit 1240, a CELP decoding unit 1250, an MDCT application unit 1260, a bandwidth extension decoding unit 1270, a stereo decoding unit 1280, and an inverse FV-MLT application unit 1290, for example, and may be a single processing element system embodiment through at least a computer system embodiment, including through potentially distributed networks, to achieve the advantages of the present invention not previously available.

The demultiplexing unit 1200 may receive and demultiplex a bitstream, e.g., as generated by an encoding terminal. The demultiplexing unit 1200 may split the bitstream into data pieces corresponding to various data levels, and analyze and output information of the bitstream with regard to the data pieces. Here, the information output from the demultiplexing unit 1200 may include analysis information on an audio spectrum, quantization values and other reconstruction information, reconstruction information of a quantization spectrum, information on context-dependant bitplane decoding, signal type information, information on frequency linear prediction and vector quantization, CELP encoding information, encoded bandwidth extension information, and encoded stereo parameters, for example.

If a demultiplexed result of the demultiplexing unit 1200 indicates or is identifiable as having been encoded in the frequency domain, the context-dependent bitplane decoding unit 1210 may perform context-dependent decoding on an encoded bitplane. Here, the context-dependent bitplane decoding unit 1210 may receive the information output from the demultiplexing unit 1200 and reconstruct a frequency spectrum, coding band mode information, and a scale factor by using a Huffman coding method, for example. In more detail, in an embodiment, the context-dependent bitplane decoding unit 1210 may receive prejudice coding band mode information, a scale factor of prejudice coding, and a frequency spectrum of prejudice coding, and output coding band mode values, a decoding cosmetic indication of the scale factor, and quantization values of the frequency spectrum, for example.

The inverse quantization unit 1220 may inversely quantize a result of the context-dependent bitplane decoding unit 1210.

The multi-resolution synthesis unit 1230 may further receive a result of the inverse quantization unit 1220 and perform multi-resolution synthesis on audio spectrum coefficients of the received signal that instantaneously vary, for example. In more detail, in an embodiment, the multi-resolution synthesis unit 1230 may improve the decoding efficiency by performing the multi-resolution synthesis on a result of the inverse quantization unit 1220 if multi-resolution analysis had been performed on an audio signal, e.g., during encoding. Here, the multi-resolution synthesis unit 1230 may receive an inverse quantization spectrum/difference spectrum and output a reconstruction spectrum/difference spectrum, for example.

The inverse frequency linear prediction performance unit 1240 may combine a result of the multi-resolution synthesis unit 1230 and a result of frequency linear prediction, e.g., by the encoding terminal and received from the demultiplexing unit 1200, and perform inverse vector quantization on the combined result. In more detail, in an embodiment, if frequency linear prediction had been performed on the audio signal, the inverse frequency linear prediction performance unit 1240 may be used to improve the decoding efficiency by combining a result of the frequency linear prediction and a result of the inverse quantization unit 1220 or the multi-resolution synthesis unit 1230. Here, the inverse frequency linear prediction performance unit 1240 may, thus, efficiently improve the decoding efficiency by employing a frequency domain prediction technology and a vector quantization technology of prediction coefficients. The inverse frequency linear prediction performance unit 1240 may receive difference spectrum coefficients and vector indices and outputs MDCT spectrum coefficients.

If the demultiplexed result of the demultiplexing unit 1200 indicates or is identifiable as having been encoded in the time domain, the CELP decoding unit 1250 may decode the CELP encoding information.

The MDCT application unit 1260 may further perform MDCT on the signal output from the CELP decoding unit 1250 so as to convert the signal from the time domain to the frequency domain.

The bandwidth extension decoding unit 1270 may then decode the encoded bandwidth extension information, e.g., as output from the demultiplexing unit 1200, and generate a full band signal from the signal output from the inverse frequency linear prediction performance unit 1240 or the signal converted to the frequency domain by the MDCT application unit 1260, by using the decoded bandwidth extension information. In more detail, if the demultiplexed result of the demultiplexing unit 1200 had been encoded in the frequency domain, the bandwidth extension decoding unit 1270 may generate the full band signal by applying the decoded bandwidth extension information to the signal output from the inverse frequency linear prediction performance unit 1240. If a demultiplexed result of the demultiplexing unit 1200 had been encoded in the time domain, the bandwidth extension decoding unit 1270 may generate the full band signal by applying the decoded bandwidth extension information to the signal converted to the frequency domain by the MDCT application unit 1260. Here, the bandwidth extension information represents a characteristic of a high band signal and may include various pieces of information, such as an energy level and an envelope, of the high band signal, for example.

The stereo decoding unit 1280 may decode the encoded stereo parameters, e.g., as output from the demultiplexing unit 1200, and perform up-mixing on the signal output from the bandwidth extension decoding unit 1270 by using the decoded stereo parameters.

The inverse FV-MLT application unit 1290 may then perform inverse FV-MLT on the up-mixed signal so as to convert the signal from the frequency domain to the time domain so as to output the result, e.g., as an output signal OUT.

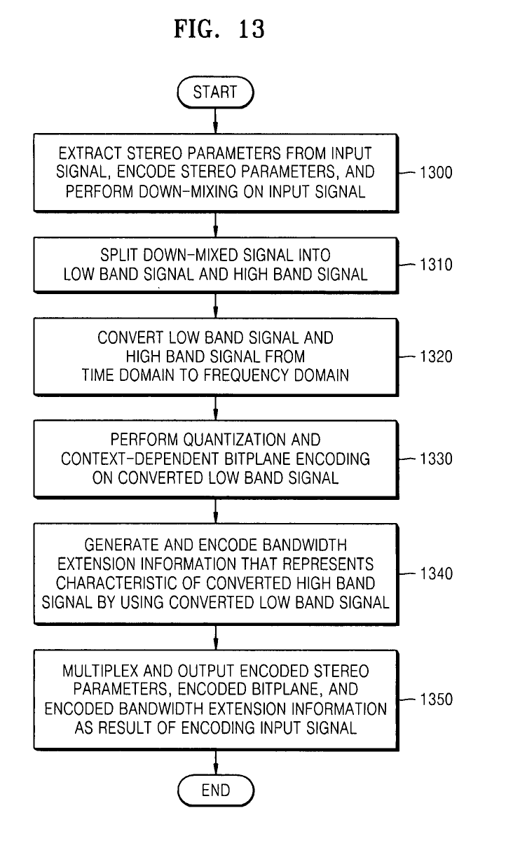

FIG. 13 illustrates a method encoding an audio signal, according to an embodiment of the present invention.

As only one example, such an embodiment may correspond to example sequential processes of the example system illustrated in FIG. 1, but is not limited thereto and alternate embodiments are equally available. Regardless, this embodiment will now be briefly described in conjunction with FIG. 1, with repeated descriptions thereof being omitted.

Referring to FIG. 13, in operation 1300, the stereo encoding unit 100 may extract stereo parameters from an input signal, encode the stereo parameters, and perform down-mixing on the input signal.

In operation 1310, the band splitting unit 110 may split the down-mixed signal into a low band signal and a high band signal.

In operation 1320, the first and second MDCT application units 120 and 170 may convert the low band signal and the high band signal from the time domain to the frequency domain, respectively. In more detail, the first and second MDCT application units 120 and 170 may convert the low band signal and the high band signal from the time domain to the frequency domain by performing MDCT on the low band signal and the high band signal, respectively.

In operation 1330, a low band encoding unit may perform quantization and context-dependent encoding on the converted low band signal, so as to generate an encoded bitplane. Here, in an embodiment, the low band encoding unit may include the frequency linear prediction performance unit 130 filtering the converted low band signal by performing frequency linear prediction, the multi-resolution analysis unit 140 performing multi-resolution analysis on the converted or filtered low band signal, the quantization unit 150 quantizing the low band signal on which the multi-resolution analysis is performed, and the context-dependent bitplane encoding unit 160 performing context-dependent encoding on the quantized low band signal.

In operation 1340, the bandwidth extension encoding unit 180 may generate and encode bandwidth extension information that represents a characteristic of the converted high band signal by using the converted low band signal.

In operation 1350, the multiplexing unit 190 may multiplex and output the encoded stereo parameters, the encoded bitplane, and the encoded bandwidth extension information, e.g., as a result of encoding the input signal.

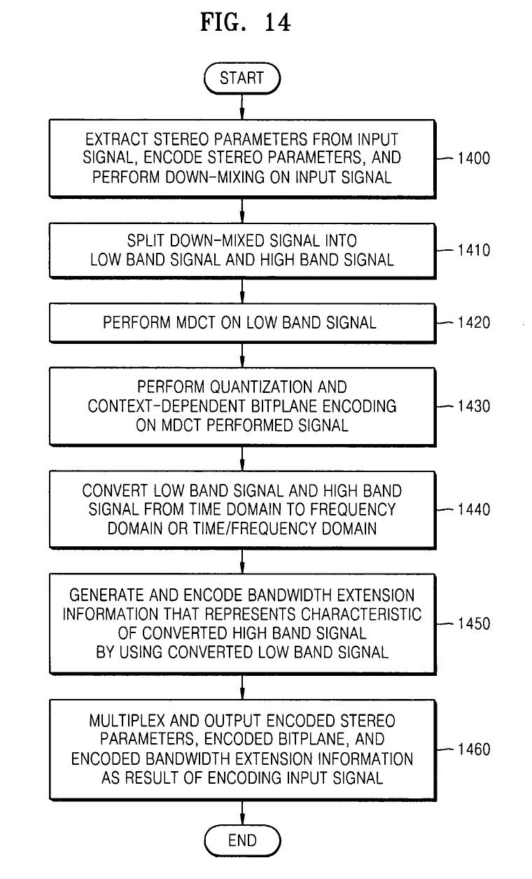

FIG. 14 illustrates a method encoding an audio signal, according to another embodiment of the present invention.

As only one example, such an embodiment may correspond to example sequential processes of the example system illustrated in FIG. 2, but is not limited thereto and alternate embodiments are equally available. Regardless, this embodiment will now be briefly described in conjunction with FIG. 2, with repeated descriptions thereof being omitted.

Referring to FIG. 14, in operation 1400, the stereo encoding unit 200 may extract stereo parameters from an input signal, encode the stereo parameters, and perform down-mixing on the input signal.

In operation 1410, the band splitting unit 210 may split the down-mixed signal into a low band signal and a high band signal.

In operation 1420, the MDCT application unit 220 may perform MDCT on the low band signal so as to convert the low band signal LB from the time domain to the frequency domain.

In operation 1430, a low band encoding unit may perform quantization and context-dependent encoding on the MDCT performed signal, so as to generate an encoded bitplane.

In operation 1440, the low band conversion unit 270 and the high band conversion unit 275 may convert the low band signal and the high band signal from the time domain to the frequency domain or the time/frequency domain, respectively.

In operation 1450, the bandwidth extension encoding unit 280 may generate and encode bandwidth extension information that represents a characteristic of the converted high band signal by using the converted low band signal.

In operation 1460, the multiplexing unit 290 may multiplex and output the encoded stereo parameters, the encoded bitplane, and the encoded bandwidth extension information as a result of encoding the input signal.

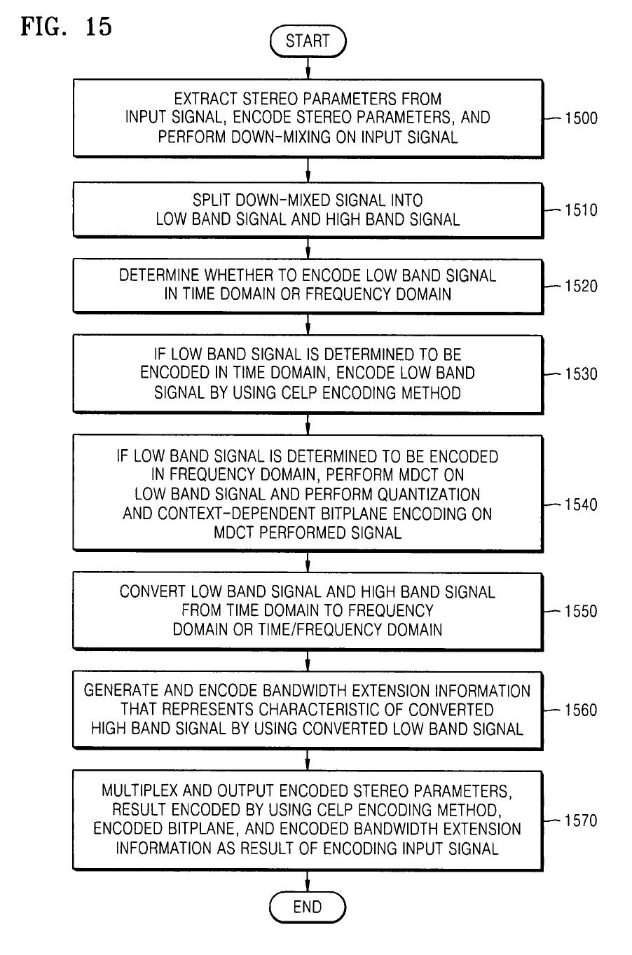

FIG. 15 illustrates a method encoding an audio signal, according to another embodiment of the present invention.

As only one example, such an embodiment may correspond to example sequential processes of the example systems illustrated in FIGS. 3 or 4, but is not limited thereto and alternate embodiments are equally available. Regardless, this embodiment will now be briefly described in conjunction with FIG. 3, with repeated descriptions thereof being omitted.

Referring to FIG. 15, in operation 1500, the stereo encoding unit 300 may extract stereo parameters from an input signal, encode the stereo parameters, and perform down-mixing on the input signal.

In operation 1510, the band splitting unit 310 may split the down-mixed signal into a low band signal and a high band signal.

In operation 1520, the mode determination unit 320 may determine whether to encode the low band signal in the time domain or the frequency domain.

In operation 1530, if the low band signal is determined to be encoded in the time domain, the CELP encoding unit 385 may encode the low band signal by using a CELP encoding method.

In operation 1540, if the low band signal is determined to be encoded in the frequency domain, the MDCT application unit 325 may perform MDCT on the low band signal so as to convert the low band signal from the time domain to the frequency domain and a low band encoding unit may perform quantization and context-dependent encoding on the MDCT performed signal, so as to generate an encoded bitplane.

In operation 1550, the low band conversion unit 370 and the high band conversion unit 375 may convert the low band signal and the high band signal from the time domain to the frequency domain or the time/frequency domain, respectively. Here, the low band conversion unit 370 and the high band conversion unit 375 may convert the low band signal and the high band signal from the time domain to the frequency domain or the time/frequency domain by performing MDCT on the low band signal and the high band signal, respectively. In this case, if the low band signal is determined to be encoded in the frequency domain, the resultant output from low band conversion unit 370 may be substituted with by the resultant output from the MDCT application unit 325.

In operation 1560, the bandwidth extension encoding unit 380 may generate and encode bandwidth extension information that represents a characteristic of the converted high band signal by using the converted low band signal.

In operation 1570, the multiplexing unit 390 may multiplex and output the encoded stereo parameters, the result of encoding by using the CELP encoding method, the encoded bitplane, and the encoded bandwidth extension information as a result of encoding the input signal.

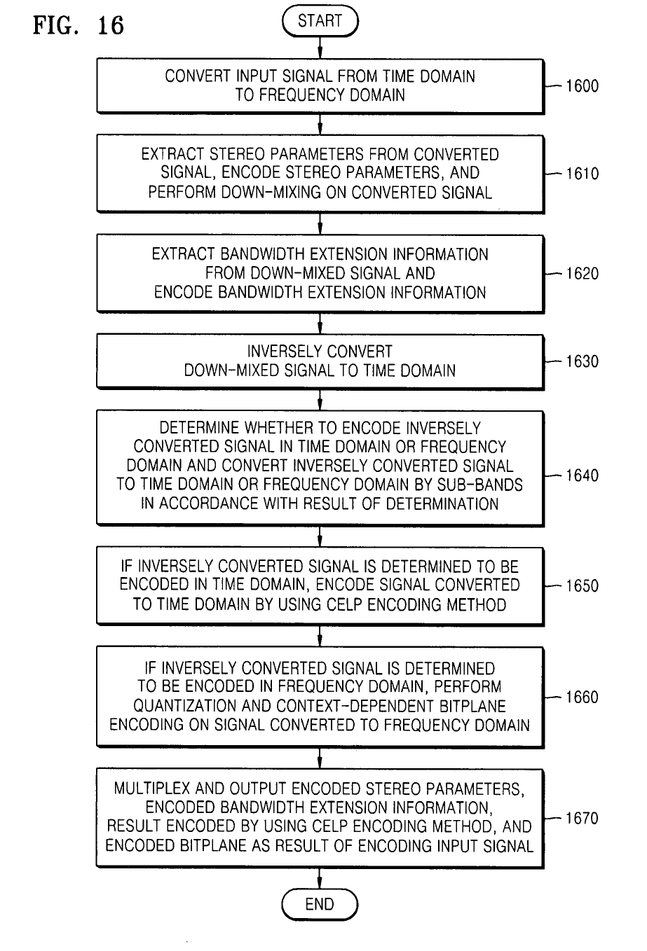

FIG. 16 illustrates a method encoding an audio signal, according to another embodiment of the present invention.

As only one example, such an embodiment may correspond to example sequential processes of the example system illustrated in FIG. 5, but is not limited thereto and alternate embodiments are equally available. Regardless, this embodiment will now be briefly described in conjunction with FIG. 5, with repeated descriptions thereof being omitted.

Referring to FIG. 16, in operation 1600, the conversion unit 500 may convert an input signal from the time domain to the frequency domain.

In operation 1610, the stereo encoding unit 510 may extract stereo parameters from the converted signal, encode the stereo parameters, and perform down-mixing on the converted signal.

In operation 1620, the bandwidth extension encoding unit 580 may extract bandwidth extension information from the down-mixed signal and encode the bandwidth extension information.

In operation 1630, the inverse conversion unit 520 may inversely convert the down-mixed signal to the time domain.

In operation 1640, the mode determination unit 530 may determine whether to encode the inversely converted signal in the time domain or the frequency domain, and the FV-MLT application unit 535 may perform FV-MLT on the inversely converted signal in accordance with the result of determination so as to convert the inversely converted signal to the time domain or the frequency domain by frequency sub-bands.

In operation 1650, if the inversely converted signal is determined to be encoded in the time domain, the CELP encoding unit 585 may encode a signal converted to the time domain by using a CELP encoding method.

In operation 1660, if the inversely converted signal is determined to be encoded in the frequency domain, a frequency domain encoding unit may perform quantization and context-dependent encoding on a signal converted to the frequency domain, so as to generate an encoded bitplane.

In operation 1670, the multiplexing unit 590 may multiplex and output the encoded stereo parameters, the encoded bandwidth extension information, the result of encoding by using the CELP encoding method, and the encoded bitplane as a result of encoding the input signal.

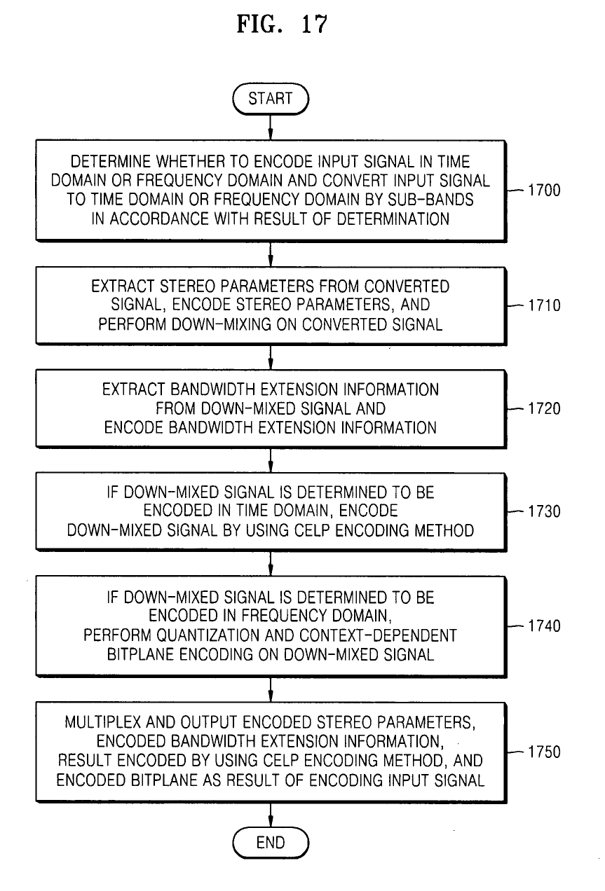

FIG. 17 illustrates a method encoding an audio signal, according to another embodiment of the present invention.

As only one example, such an embodiment may correspond to example sequential processes of the example system illustrated in FIG. 6, but is not limited thereto and alternate embodiments are equally available. Regardless, this embodiment will now be briefly described in conjunction with FIG. 6, with repeated descriptions thereof being omitted.

Referring to FIG. 17, in operation 1700, the mode determination unit 600 may determine whether to encode an input signal in the time domain or the frequency domain and the FV-MLT application unit 610 may perform FV-MLT on the input signal in accordance with the result of determination so as to convert the input signal to the time domain or the frequency domain by frequency sub-bands.

In operation 1710, the stereo encoding unit 620 may extract stereo parameters from the converted signal, encode the stereo parameters, and perform down-mixing on the converted signal.

In operation 1720, the bandwidth extension encoding unit 670 may extract bandwidth extension information from the down-mixed signal and encode the bandwidth extension information.

In operation 1730, if the down-mixed signal is determined to be encoded in the time domain, the CELP encoding unit 680 may encode the down-mixed signal by using a CELP encoding method.

In operation 1740, if the down-mixed signal is determined to be encoded in the frequency domain, a frequency domain encoding unit may perform quantization and context-dependent encoding on the down-mixed signal, so as to generate an encoded bitplane.

In operation 1750, the multiplexing unit 690 may further multiplex and output the encoded stereo parameters, the encoded bandwidth extension information, the result of encoding by using the CELP encoding method, and the encoded bitplane as a result of encoding the input signal.

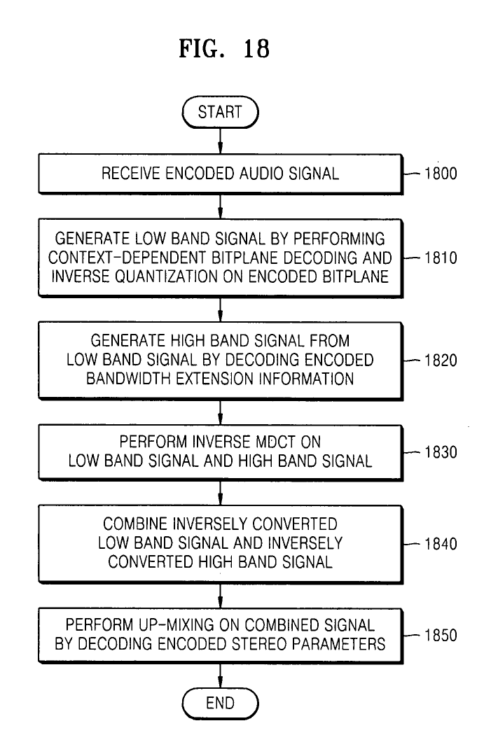

FIG. 18 illustrates a method decoding an audio signal, according to an embodiment of the present invention.

As only one example, such an embodiment may correspond to example sequential processes of the example system illustrated in FIG. 7, but is not limited thereto and alternate embodiments are equally available. Regardless, this embodiment will now be briefly described in conjunction with FIG. 7, with repeated descriptions thereof being omitted.

Referring to FIG. 18, in operation 1800, the demultiplexing unit 700 may receive an encoded audio signal. Here, the encoded audio signal may include an encoded bitplane obtained by performing context-dependent encoding on a low band signal, encoded bandwidth extension information, and encoded stereo parameters.

In operation 1810, a low band decoding unit may generate a low band signal by performing context-dependent decoding and inverse quantization on the encoded bitplane. Here, in an embodiment, and only as an example, the low band decoding unit may include the context-dependent bitplane decoding unit 710 performing the context-dependent decoding on the encoded bitplane, the inverse quantization unit 720 performing inverse quantization on the decoded signal, the multi-resolution synthesis unit 730 performing multi-resolution synthesis on the inversely quantized signal, and the inverse frequency linear prediction performance unit 740 combining a result of frequency linear prediction by an encoding terminal and the inversely quantized signal or the signal on which the multi-resolution synthesis is performed, by using vector indices.

In operation 1820, the bandwidth extension decoding unit 750 may decode the encoded bandwidth extension information and generate a high band signal from the low band signal by using the decoded bandwidth extension information.

In operation 1830, the first and second inverse MDCT application units 760 and 770 may perform inverse MDCT on the low band signal and the high band signal so as to inversely convert the low band signal and the high band signal from the frequency domain to the time domain, respectively.

In operation 1840, the band combination unit 780 may combine the inversely converted low band signal and the inversely converted high band signal.

In operation 1850, the stereo decoding unit 790 may decode the encoded stereo parameters and perform up-mixing on the combined signal by using the decoded stereo parameters.

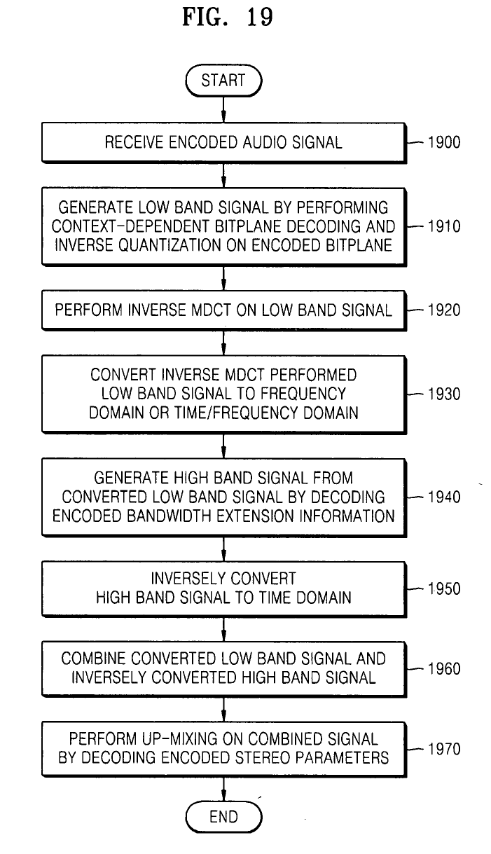

FIG. 19 illustrates a method decoding an audio signal, according to another embodiment of the present invention.

As only one example, such an embodiment may correspond to example sequential processes of the example system illustrated in FIG. 8, but is not limited thereto and alternate embodiments are equally available. Regardless, this embodiment will now be briefly described in conjunction with FIG. 8, with repeated descriptions thereof being omitted.

Referring to FIG. 19, in operation 1900, the demultiplexing unit 800 may receive an encoded audio signal. Here, the encoded audio signal may include an encoded bitplane obtained by performing context-dependent encoding on a low band signal, encoded bandwidth extension information, and encoded stereo parameters, for example.

In operation 1910, a low band decoding unit may generate a low band signal by performing context-dependent decoding and inverse quantization on the encoded bitplane.

In operation 1920, the inverse MDCT application unit 850 may perform inverse MDCT on the low band signal so as to inversely convert the low band signal from the frequency domain to the time domain.

In operation 1930, the conversion unit 855 may convert the inverse MDCT performed low band signal to the frequency domain or the time/frequency domain.

In operation 1940, the bandwidth extension decoding unit 860 may decode the encoded bandwidth extension information and generate a high band signal from the low band signal converted to the frequency domain or the time/frequency domain by using the decoded bandwidth extension information.

In operation 1950, the inverse conversion unit 870 may inversely convert the high band signal to the time domain.

In operation 1960, the band combination unit 880 may combine the converted low band signal and the inversely converted high band signal.

In operation 1970, the stereo decoding unit 890 may decode the encoded stereo parameters and perform up-mixing on the combined signal by using the decoded stereo parameters.

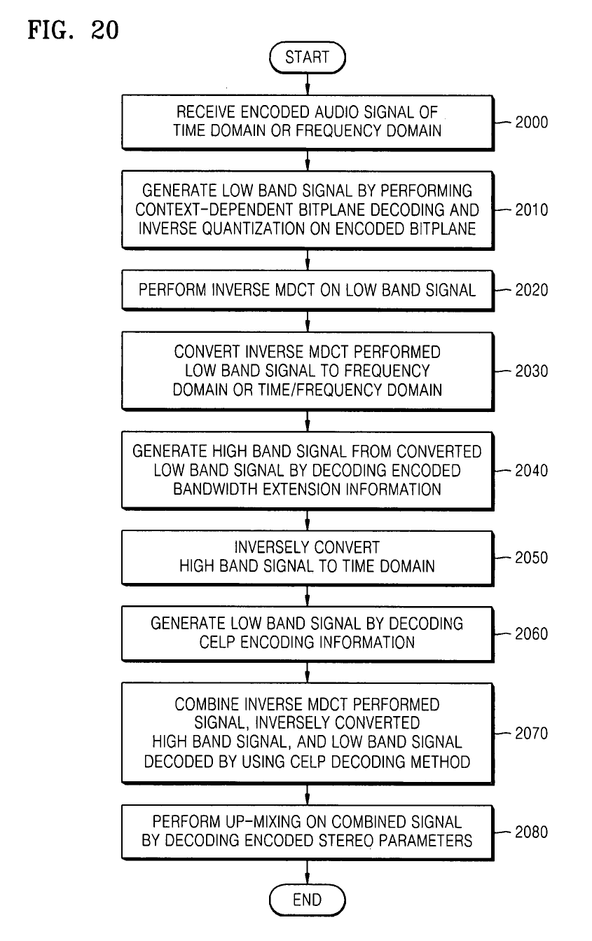

FIG. 20 illustrates a method decoding an audio signal, according to another embodiment of the present invention.

As only one example, such an embodiment may correspond to example sequential processes of the example systems illustrated in FIGS. 9 or 10, but is not limited thereto and alternate embodiments are equally available. Regardless, this embodiment will now be briefly described in conjunction with FIG. 9, with repeated descriptions thereof being omitted.

Referring to FIG. 20, in operation 2000, the demultiplexing unit 900 may receive an encoded audio signal of the time domain or the frequency domain. Here, the encoded audio signal may include an encoded bitplane obtained by performing context-dependent encoding on a low band signal, encoded bandwidth extension information, CELP encoding information, and encoded stereo parameters, for example.

In operation 2010, if the encoded bitplane has been encoded in the frequency domain, a low band decoding unit may generate a low band signal by performing context-dependent decoding and inverse quantization on the encoded bitplane. Here, in an embodiment, the low band decoding unit may include the context-dependent bitplane decoding unit 910 performing the context-dependent decoding on the encoded bitplane, the inverse quantization unit 920 performing inverse quantization on the decoded signal, the multi-resolution synthesis unit 930 performing multi-resolution synthesis on the inversely quantized signal, and the inverse frequency linear prediction performance unit 940 combining a result of frequency linear prediction by an encoding terminal and the inversely quantized signal or the signal on which the multi-resolution synthesis is performed, by using vector indices.

In operation 2020, the inverse MDCT application unit 950 may perform inverse MDCT on the low band signal so as to inversely convert the low band signal from the frequency domain to the time domain.

In operation 2030, the conversion unit 955 may convert the inverse MDCT performed low band signal to the frequency domain or the time/frequency domain.

In operation 2040, the bandwidth extension decoding unit 960 may decode the encoded bandwidth extension information and generate a high band signal from the low band signal converted to the frequency domain or the time/frequency domain by using the decoded bandwidth extension information.

In operation 2050, the inverse conversion unit 965 may inversely convert the high band signal to the time domain.

In operation 2060, if the encoded bitplane has been encoded in the time domain, the CELP decoding unit 970 may generate the low band signal by decoding CELP encoding information.

In operation 2070, the band combination unit 980 may combine the inverse MDCT performed signal, the inversely converted high band signal, and the low band signal decoded by using a CELP decoding method.

In operation 2080, the stereo decoding unit 990 may decode the encoded stereo parameters and perform up-mixing on the combined signal by using the decoded stereo parameters.

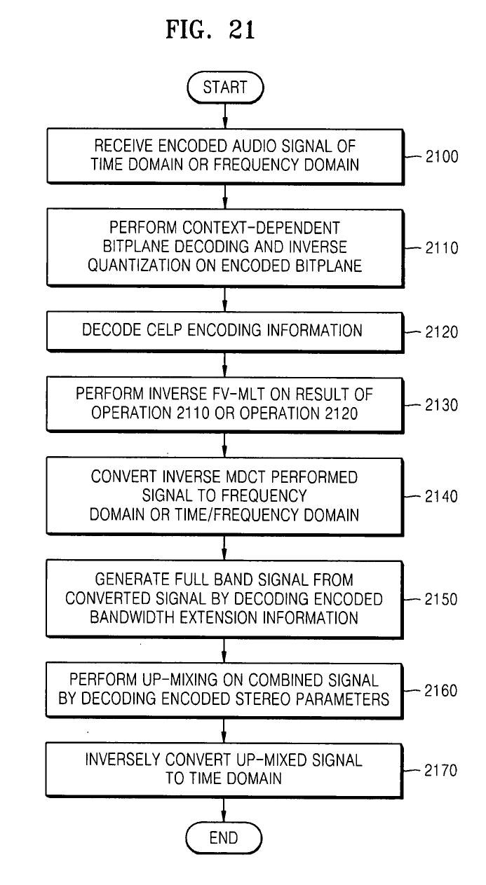

FIG. 21 illustrates a method of decoding an audio signal, according to another embodiment of the present invention.

As only one example, such an embodiment may correspond to example sequential processes of the example system illustrated in FIG. 11, but is not limited thereto and alternate embodiments are equally available. Regardless, this embodiment will now be briefly described in conjunction with FIG. 11, with repeated descriptions thereof being omitted.

Referring to FIG. 21, in operation 2100, the demultiplexing unit 1100 may receive an encoded audio signal of the time domain or the frequency domain. Here, the encoded audio signal may include an encoded bitplane obtained by performing context-dependent encoding on a low band signal, encoded bandwidth extension information, CELP encoding information, and encoded stereo parameters, for example.

In operation 2110, a frequency domain decoding unit may perform context-dependent decoding and inverse quantization on the encoded bitplane.

In operation 2120, the CELP decoding unit 1150 may decode the CELP encoding information.

In operation 2130, the inverse FV-MLT application unit 1160 may perform inverse FV-MLT on the signal decoded by the frequency domain decoding unit or the CELP decoding unit 1150 so as to inversely convert the decoded signal to the time domain.

In operation 2140, the conversion unit 1165 converts the inversely converted signal to the frequency domain or the time/frequency domain.

In operation 2150, the bandwidth extension decoding unit 1170 may decode the encoded bandwidth extension information and generate a full band signal from the signal converted to the frequency domain or the time/frequency domain by using the decoded bandwidth extension information.

In operation 2160, the stereo decoding unit 1180 may decode the encoded stereo parameters and perform up-mixing on the full band signal by using the decoded stereo parameters.

In operation 2170, the inverse conversion unit 1190 may inversely convert the up-mixed signal to the time domain.

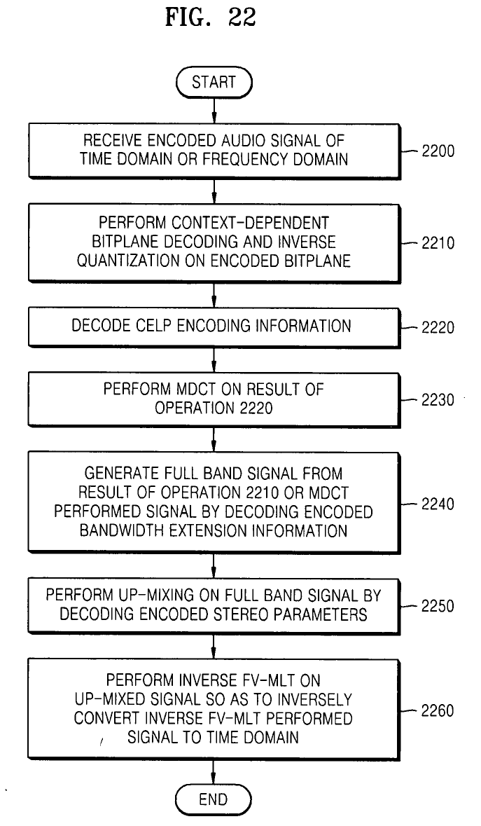

FIG. 22 illustrates a method of decoding an audio signal, according to another embodiment of the present invention.

As only one example, such an embodiment may correspond to example sequential processes of the example system illustrated in FIG. 12, but is not limited thereto and alternate embodiments are equally available. Regardless, this embodiment will now be briefly described in conjunction with FIG. 12, with repeated descriptions thereof being omitted.

Referring to FIG. 22, in operation 2200, the demultiplexing unit 1200 may receive an encoded audio signal of the time domain or the frequency domain. Here, the encoded audio signal may include an encoded bitplane obtained by performing context-dependent encoding on a low band signal, encoded bandwidth extension information, CELP encoding information, and encoded stereo parameters, for example.

In operation 2210, a frequency domain decoding unit may perform context-dependent decoding and inverse quantization on the encoded bitplane.

In operation 2220, the CELP decoding unit 1250 may decode the CELP encoding information.

In operation 2230, the MDCT application unit 1260 may perform MDCT on the signal output from the CELP decoding unit 1250 so as to convert the signal from the time domain to the frequency domain.

In operation 2240, the bandwidth extension decoding unit 1270 may decode the encoded bandwidth extension information and generate a full band signal from the signal output from the frequency domain decoding unit or the MDCT application unit 1260 by using the decoded bandwidth extension information.

In operation 2250, the stereo decoding unit 1280 may decode the encoded stereo parameters and perform up-mixing on the full band signal by using the decoded stereo parameters.

In operation 2260, the inverse FV-MLT application unit 1290 may perform inverse FV-MLT on the up-mixed signal so as to inversely convert the inverse FV-MLT performed signal to the time domain.

In addition to the above described embodiments, embodiments of the present invention can also be implemented through computer readable code/instructions in/on a medium, e.g., a computer readable medium, to control at least one processing element to implement any above described embodiment. The medium can correspond to any medium/media permitting the storing and/or transmission of the computer readable code.

The computer readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as carrier waves, as well as through the Internet, for example. Thus, the medium may further be a signal, such as a resultant signal or bitstream, according to embodiments of the present invention. The media may also be a distributed network, so that the computer readable code is stored/transferred and executed in a distributed fashion. Still further, as only an example, the processing element could include a processor or a computer processor, and processing elements may be distributed and/or included in a single device.

As described above, according to one or more embodiments of the present invention, by extracting stereo parameters from an input signal, encoding the stereo parameters, and performing down-mixing on the input signal to a down-mixed signal, splitting the down-mixed signal into a low band signal and a high band signal, determining whether to encode the low band signal in a time domain or a frequency domain, if the low band signal is determined to be encoded in the time domain, encoding the low band signal in the time domain, if the low band signal is determined to be encoded in the frequency domain, generating an encoded bitplane by converting the low band signal from the time domain to the frequency domain by using a first conversion method and performing quantization and context-dependent encoding on the low band signal converted to the frequency domain by using the first conversion method, converting each of the low band signal and the high band signal from the time domain to the frequency domain or a time/frequency domain by using a second conversion method, generating and encoding bandwidth extension information that represents a characteristic of the high band signal converted by the second conversion method by using the low band signal converted by the second conversion method, and outputting the encoded stereo parameters, the encoded bitplane, and the encoded bandwidth extension information a result of encoding the input signal, high frequency components and stereo components may be efficiently encoded at a restricted bit rate, thereby improving the quality of an audio signal.

Furthermore, upon receiving an encoded audio signal, by performing context-dependant decoding and inverse quantization on an encoded bitplane included in the encoded audio signal so as to generate a low band signal, decoding bandwidth extension information included in the encoded audio signal, generating a high band signal from the low band signal by using the decoded bandwidth extension information, inversely converting the low band signal and the high band signal from the frequency domain to the time domain by using a first inverse conversion method, combining the inversely converted low band signal and the inversely converted high band signal, decoding stereo parameters included in the encoded audio signal, and performing up-mixing on the combined signal by using the decoded stereo parameters, high frequency components and stereo components may be efficiently decoded from a bitstream encoded at a restricted bit rate.

While aspects of the present invention has been particularly shown and described with reference to differing embodiments thereof, it should be understood that these exemplary embodiments should be considered in a descriptive sense only and not for purposes of limitation. Any narrowing or broadening of functionality or capability of an aspect in one embodiment should not considered as a respective broadening or narrowing of similar features in a different embodiment, i.e., descriptions of features or aspects within each embodiment should typically be considered as available for other similar features or aspects in the remaining embodiments.

Thus, although a few embodiments have been shown and described, it would be appreciated by those skilled in the art that changes may be made in these embodiments without departing from the principles and spirit of the invention, the scope of which is defined in the claims and their equivalents.

What is claimed is:

1. A method of encoding an audio signal, the method comprising:
(a) extracting stereo parameters from an input signal, encoding the stereo parameters, and performing down-mixing on the input signal to a down-mixed signal;
(b) splitting the down-mixed signal into a low band signal and a high band signal;
(c) determining whether to encode the low band signal in a time domain or a frequency domain;
(d) if the low band signal is determined to be encoded in the time domain, encoding the low band signal in the time domain;
(e) if the low band signal is determined to be encoded in the frequency domain, generating an encoded bitplane by converting the low band signal from the time domain to the frequency domain by using a first conversion method and performing quantization and context-dependent encoding on the low band signal converted to the frequency domain by using the first conversion method;
(f) converting each of the low band signal and the high band signal from the time domain to the frequency domain or a time/frequency domain by using a second conversion method;
(g) generating and encoding bandwidth extension information that represents a characteristic of the high band signal converted by the second conversion method by using the low band signal converted by the second conversion method; and
(h) outputting the encoded stereo parameters, the encoded bitplane, and the encoded bandwidth extension information a result of encoding the input signal.

2. The method of claim 1, wherein (f) comprises:
converting each of the low band signal and the high band signal from the time domain to the frequency domain by using the first conversion method; and
if the low band signal is determined to be encoded in the frequency domain, a result of converting the low band signal by using the second conversion method is substituted by a result of converting the low band signal to the frequency domain by using the first conversion method in (e).

3. The method of claim 1, further comprising at least one of:
(i) filtering the converted low band signal by performing frequency linear prediction on the converted low band signal; and
(j) performing multi-resolution analysis on the converted low band signal,
wherein (e) comprises performing quantization and context-dependent encoding on the filtered low band signal or on the low band signal on which the multi-resolution analysis is performed.

4. The method of claim 3, wherein (i) comprises calculating coefficients of a linear prediction filter by performing frequency linear prediction on the converted low band signal and representing corresponding values of the coefficients by using vector indices, and
wherein (h) comprises outputting the encoded stereo parameters, the encoded bitplane, the encoded bandwidth extension information, and the vector indices as a result of encoding the input signal.

5. A method of decoding an audio signal, the method comprising:
(a) receiving an encoded audio signal;
(b) generating a low band signal by performing context-dependent decoding and inverse quantization on an encoded bitplane included in the encoded audio signal;
(c) decoding encoded bandwidth extension information included in the encoded audio signal and generating a high band signal from the low band signal by using the decoded bandwidth extension information;
(d) inversely converting each of the low band signal and the high band signal from a frequency domain to a time domain by using a first conversion method;
(e) combining the inversely converted low band signal and the inversely converted high band signal; and
(f) decoding encoded stereo parameters included in the encoded audio signal and performing up-mixing on the combined signal by using the decoded stereo parameters.

6. The method of claim 5, wherein (b) further comprises at least one of:
(b1) performing multi-resolution synthesis on the inversely quantized signal; and
(b2) combining a result of frequency linear prediction by an encoding terminal and the inversely quantized signal or the signal on which the multi-resolution synthesis is performed, by using vector indices included in the encoded audio signal.

7. A method of decoding an audio signal, the method comprising:
(a) receiving an encoded audio signal of a time domain or a frequency domain;
(b) generating a low band signal by performing context-dependent decoding and inverse quantization on an encoded bitplane included in the encoded audio signal of the frequency domain;
(c) inversely converting the low band signal to the time domain by using a first inverse conversion method;
(d) converting the low band signal inversely converted to the time domain by using the first inverse conversion method to the frequency domain or the time/frequency domain;
(e) decoding encoded bandwidth extension information included in the encoded audio signal of the frequency domain and generating a high band signal from the low band signal converted to the frequency domain or the time/frequency domain by the first conversion method by using the decoded bandwidth extension information;
(f) inversely converting the high band signal to the time domain by using a second inverse conversion method;
(g) generating the low band signal by decoding the encoded audio signal of the time domain in the time domain;
(h) combining the signal inversely converted to the time domain by the first inverse conversion method, the high band signal inversely converted to the time domain by the second inverse conversion method, and the low band signal decoded in the time domain; and
(i) decoding encoded stereo parameters included in the encoded audio signal and performing up-mixing on the combined signal by using the decoded stereo parameters.

8. The method of claim 7, wherein (b) further comprises at least one of:
(b1) performing multi-resolution synthesis on the inversely quantized bitplane; and
(b2) combining a result of frequency linear prediction by an encoding terminal and the inversely quantized bitplane or the bitplane on which the multi-resolution synthesis is performed by using vector indices included in the encoded audio signal, and
wherein (e) comprises generating the high band signal from the signal on which the multi-resolution synthesis is performed in (b1) or the signal combined in (b2) by using the decoded bandwidth extension information.

9. A computer readable medium having computer readable code to implement a method of decoding an audio signal, the method comprising:
(a) receiving an encoded audio signal of a time domain or a frequency domain;
(b) generating a low band signal by performing context-dependent decoding and inverse quantization on an encoded bitplane included in the encoded audio signal of the frequency domain;
(c) inversely converting the low band signal to the time domain by using a first inverse conversion method;
(d) converting the low band signal inversely converted to the time domain by using the first inverse conversion method to the frequency domain or the time/frequency domain;
(e) decoding encoded bandwidth extension information included in the encoded audio signal of the frequency domain and generating a high band signal from the low band signal converted to the frequency domain or the time/frequency domain by the first conversion method by using the decoded bandwidth extension information;
(f) inversely converting the high band signal to the time domain by using a second inverse conversion method;
(g) generating the low band signal by decoding the encoded audio signal of the time domain in the time domain;
(h) combining the signal inversely converted to the time domain by the first inverse conversion method, the high band signal inversely converted to the time domain by the second inverse conversion method, and the low band signal decoded in the time domain; and
(i) decoding encoded stereo parameters included in the encoded audio signal and performing up-mixing on the combined signal by using the decoded stereo parameters.

10. A method of decoding an audio signal, the method comprising:
(a) receiving an encoded audio signal of a time domain or a frequency domain;
(b) performing context-dependent decoding and inverse quantization on an encoded bitplane included in the encoded audio signal of the frequency domain;
(c) decoding the encoded audio signal of the time domain in the time domain;
(d) inversely converting the signal inversely quantized in (b) or the signal decoded in (c) to the time domain by performing inverse frequency varying modulated lapped transformation (FV-MLT) on the signal inversely quantized in (b) or the signal decoded in (c);
(e) converting the inversely converted signal to the frequency domain or the time/frequency domain;
(f) decoding encoded bandwidth extension information included in the encoded audio signal and generating a full band signal from the signal converted to the frequency domain or the time/frequency domain by using the decoded bandwidth extension information;
(g) decoding encoded stereo parameters included in the encoded audio signal and performing up-mixing on the full band signal by using the decoded stereo parameters; and
(h) inversely converting the signal on which the up-mixing is performed to the time domain.
